(19) United States
(12) Patent Application Publication
(10) Pub. No.: US 2008/0058072 A1
(43) Pub. Date: Mar. 6, 2008

(54) Gaming machine

(75) Inventors: Kazuo Okada, Tokyo (JP); Yukinori Inamura, Tokyo (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: Aruze Corporation, Tokyo (JP)

(21) Appl. No.: 11/797,658

(22) Filed: May 4, 2007

(30) Foreign Application Priority Data
May 11, 2006 (JP) JP2006-132843

(51) Int. Cl. A63F 13/00

(52) U.S. Cl. 463/20

(57) ABSTRACT

A payout rate is changed among 85%, 90%, and 95% at the predetermined timing, based on a general payout rate preset in a gaming machine and the number of games played. In accordance with a symbol lottery table that corresponds to the payout rate thus changed, a base game lottery processing and a bonus game lottery processing are executed.

### CROSS REFERENCE TO RELATED APPLICATION

This application is based upon and claims the benefit of priority from the prior Japanese Patent Application No. 2006-132843, filed on May 11, 2006, the entire contents of which are incorporated herein by reference.

### BACKGROUND OF THE INVENTION

1. Field of the Invention

The present invention relates to a gaming machine that controls a game in accordance with a set payout rate and pays out a game medium to a player based on a game result, and particularly relates to a gaming machine that changes a set payout rate to another payout rate at a predetermined timing thereby enabling a wide range of payout rates to be set, so as to make waves in a game.

2. Description of Related Art

Conventionally, in a gaming machine such as a slot machine, a card game machine, and the like, a game starts when a game medium such as a coin is inserted into the gaming machine, and then a game result is displayed based on a result of an internal lottery that is held inside the gaming machine. For example, in a slot machine a predetermined symbol is stopped on a payline, and in a card game machine a kind of card drawn is displayed. The gaming machine is adapted to pay out a predetermined amount of game media based on the game result.

Here, the internal lottery which determines the game result is held based on a payout rate preset in the gaming machine. More specifically, in a slot machine as shown in JP-T No. 2002-537874, pages 31 to 36 and FIG. 1 (the term “JP-T” used herein means a published Japanese translation of a PCT application), a combination of symbols which will be stopped on a payline in a base game or a free game is determined by a lottery that is held based on a payout rate preset in each gaming machine. In a gaming machine, a number, a mark, and the like of a card drawn are determined by a lottery that is held based on a payout rate preset in each gaming machine. A payout to a player is adjusted to get closer to the set payout rate.

In the conventional gaming machine mentioned above, three levels of payout rates such as 85%, 90%, and 95% can be set. However, in order to change a payout rate once set to another payout rate, a staff of a game shop has to operate an inside of an apparatus and manually change the payout rate. Nevertheless, it has been difficult to change the payout rate once set, because a game shop in which such a gaming machine is placed often opens around the clock, and also because of security problems. Thus, as time elapses, a great gap appears between amounts of game media paid out from differently-set gaming machines. Therefore, a player can recognize whether each gaming machine is set at a higher or lower payout rate. Consequently, customers concentrate only on a gaming machine set at a high payout rate.

Moreover, in a conventional gaming machine having its payout rate unchangeable, the number of times a game is won per unit time, the number of payouts per unit time, and the like do not largely change as time elapses. A player playing a game in such a constant stream for a long time may be bored with the game.

The present invention is accomplished for the purpose of solving the conventional problems mentioned above. An object of the present invention is to provide a gaming machine that can set a wide range of payout rates without requiring a staff of a game shop to perform a payout-rate changing operation, to thereby prevent customers in the game shop from concentrating on a particular gaming machine and at the same time, by making waves in a game, prevent players from being bored even when they are playing the game for a long time.

### SUMMARY OF THE INVENTION

In order to attain the object, according to claim 1 of the present invention, there is provided a gaming machine (e.g., a slot machine 1) including a game medium insertion unit (e.g., a coin reception slot 21) into which a game medium is inserted, a payout rate setting unit (e.g., a main CPU 42 in S2) that sets a payout rate of the gaming machine at one of a plurality of levels of payout rates, a game control unit (e.g., a main CPU 41) that controls a game based on a payout rate set by the payout rate setting unit, and a game medium payout unit (e.g., a main CPU 41 in S20, S111, S211, S310, S411, and S511) that pays out a game medium to a player based on a game result and a game medium inserted into the game medium insertion unit. The gaming machine comprises a payout rate changing unit (e.g., a main CPU 41 in S14, S105, S205, S306, S405, S505) that changes a payout rate set by the payout rate setting unit to another payout rate at a predetermined timing.

According to claim 2 of the present invention, the gaming machine of claim 1 (e.g., a slot machine 1) comprises a time detection unit (e.g., a timer 29) that detects a current date or a current time. When a predetermined date or time comes, the payout rate changing unit (e.g., a main CPU 41 in S105) changes a payout rate to another payout rate.

According to claim 3 of the present invention, the gaming machine of claim 1 (e.g., a slot machine 1) comprises an operation time detection unit (e.g., a timer 29) that detects operation time of the gaming machine. When operation time of the gaming machine reaches a predetermined time, the payout rate changing unit (e.g., a main CPU 41 in S205) changes a payout rate to another payout rate.

According to claim 4 of the present invention, the gaming machine of claim 1 (e.g., a slot machine 1) comprises a win determination unit (e.g., a main CPU 41 in S305) that determines, based on a result of game control made by the game control unit (e.g., a main CPU 41), whether a particular kind of win is made during a game or not. When the win determination unit determines that a particular kind of win is made, the payout rate changing unit (e.g., a main CPU 41 in S306) changes a payout rate to another payout rate.

According to claim 5 of the present invention, the gaming machine of claim 1 (e.g., a slot machine 1) comprises a value counting unit (e.g., a main CPU 41 in S403) that counts a value of a game medium inserted into the game medium insertion unit (e.g., a coin reception slot 21). When a game medium having a predetermined value is inserted into the game medium insertion unit, the payout rate changing unit (e.g., a main CPU 41 in S405) changes a payout rate to another payout rate.

According to claim 6 of the present invention, the gaming machine of claim 1 (e.g., a slot machine 1) comprises a value calculation unit (e.g., a main CPU 41 in S503) that calculates a difference between a value of a game medium inserted into the game medium insertion unit (e.g., a coin reception slot 21) and a value of a game medium paid out by the game medium payout unit (e.g., a main CPU 41 in S511). When the value calculation unit calculates out a predetermined value difference, the payout rate changing unit (e.g., a main CPU 41 in S505) changes a payout rate to another payout rate.

According to claim 11 of the present invention, there is provided a gaming machine (e.g., a slot machine 1) including a display (e.g., an upper image display panel 27, a lower image display panel 6) that displays a game, and a control unit (e.g., a main CPU) that controls the display. The control unit executes the game based on a first payout rate, stores a numerical value that is updated along with execution of the game, and executes the game based on a second payout rate that is different from the first payout rate in a case where the previously-stored numerical value becomes a certain value associated with the first payout rate beforehand.

According to claim 12 of the present invention, in the gaming machine of claim 11 (e.g., a slot machine 1), until the stored numerical value becomes a certain numerical value associated with the second payout rate beforehand, the control unit executes the game based on the second payout rate.

According to claim 13 of the present invention, in the gaming machine of claim 12 (e.g., a slot machine 1), the numerical value associated with the first payout rate beforehand and the numerical value associated with the second payout rate beforehand are set based on a predetermined payout rate, the first payout rate, and the second payout rate.

### EFFECT OF THE INVENTION

In the gaming machine according to claim 1, a payout rate set in the gaming machine is changed to another payout rate at a predetermined timing, and a game is controlled based on the payout rate thus changed. Accordingly, a wide range of payout rates can be set, without requiring a game shop side to perform a payout-rate changing operation. In addition, by changing a payout rate, customers in a game shop can be prevented from concentrating on a particular gaming machine. Besides, since waves occur in a game, a player is not bored even when he/she is playing the game for a long time.

In the gaming machine according to claim 2, a payout rate set in the gaming machine is changed to another payout rate on a predetermined day or at a predetermined time, and a game is controlled based on the payout rate thus changed. Accordingly, a wide range of payout rates can be set, without requiring a game shop side to perform a payout-rate changing operation. In addition, by changing a payout rate, customers in a game shop can be prevented from concentrating on a particular gaming machine. Besides, since waves occur in a game along with elapse of time, a player is not bored even when he/she is playing the game for a long time. Further, since a payout rate is changed on a predetermined date or at a predetermined time, the payout rate can surely be changed in accordance with elapse of time.

Moreover, a manager of a casino or a hall can easily see a current situation. Therefore, it is possible to set a lottery table for a day on which a particular event is held.

In the gaming machine according to claim 3, when operation time of the gaming machine reaches a predetermined time, a payout rate set in the gaming machine is changed to another payout rate, and a game is controlled based on the payout rate thus changed. Accordingly, a wide range of payout rates can be set, without requiring a game shop side to perform a payout-rate changing operation. In addition, by changing a payout rate, customers in a game shop can be prevented from concentrating on a particular gaming machine. Besides, since waves occur in a game along with elapse of operation time of the gaming machine, a player is not bored even when he/she is playing the game for a long time. Further, in a casino for example, average operation time for one player to operate a gaming machine is 20 minutes. Accordingly, by changing a payout rate every 20 minutes, a player can be more attracted.

In the gaming machine according to claim 4, when a particular kind of win is made, a payout rate set in the gaming machine is changed to another payout rate, and a game is controlled based on the payout rate thus changed. Accordingly, a wide range of payout rates can be set, without requiring a game shop side to perform a payout-rate changing operation. Besides, since waves occur in a game in accordance with a winning mode in the gaming machine, a player is not bored even when he/she is playing the game for a long time. The payout rate is changed upon making a win. Therefore, when a player wins, his/her expectation rises, which makes it likely that he/she will continue the game even after the win.

In the gaming machine according to claim 5, when a game medium having a predetermined value is inserted, a payout rate set in the gaming machine is changed to another payout rate, and a game is controlled based on the payout rate thus changed. Accordingly, a wide range of payout rates can be set, without requiring a game shop side to perform a payout-rate changing operation. Besides, since waves occur in a game in accordance with progress of a game in the gaming machine, a player is not bored even when he/she is playing the game for a long time. In accordance with insertion of a game medium, the payout rate is changed. Therefore, player's expectation rises upon inserting more game media, thus making a player use more coins.

In the gaming machine according to claim 6, when a predetermined value difference occurs, a payout rate set in the gaming machine is changed to another payout rate, and a game is controlled based on the payout rate thus changed. Accordingly, a wide range of payout rates can be set, without requiring a game shop side to perform a payout-rate changing operation. In addition, since waves occur in a game in accordance with income and outgo of the game, a player is not bored even when he/she is playing the game for a long time. Besides, a new payout rate is set in the gaming machine in accordance with an actual payout rate. Therefore, balance of payment of a player can be maintained.

In the gaming machine according to claim 11, the control unit executes the game based on a first payout rate, stores a numerical value that is updated along with execution of the game, and controls the game based on the changed payout rate in a case where the stored numerical value becomes a certain value associated with the first payout rate beforehand. Accordingly, a wide range of payout rates can be set, without requiring a game shop side to perform an operation for changing a payout rate. In addition, since waves occur in a game in accordance with income and outgo of the game, a player is not bored even when he/she is playing the game for a long time. Besides, a new payout rate is set in the gaming machine in accordance with an actual payout rate. Therefore, balance of payment of a player can be maintained.

In the gaming machine according to claim 12, until the stored numerical value becomes a certain numerical value associated with the second payout rate beforehand, the game is executed based on the second payout rate. Accordingly, a wider range of payout rates can be set, without requiring a game shop side to perform an operation for changing a payout rate.

In the gaming machine according to claim 13, the numerical value associated with the first payout rate beforehand and the numerical value associated with the second payout rate beforehand are set based on a predetermined payout rate, the first payout rate, and the second payout rate. Accordingly, a new payout rate is set in the gaming machine in accordance with an actual payout rate. Therefore, balance of payment of a player can be maintained.

### BRIEF DESCRIPTION OF THE DRAWINGS

Other and further objects, features and advantages of the invention will appear more fully from the following description taken in connection with the accompanying drawings in which:

FIG. 1 is a perspective view showing an appearance of a gaming machine according to a first embodiment of the present invention;

FIG. 2 schematically shows columns of symbols that are painted on outer surfaces of respective reels;

FIG. 3 is a block diagram showing a control system of a slot machine according to the first embodiment;

FIG. 4 is for explaining payout rates and timings of changing the payout rates, in the slot machine according to the first embodiment;

FIG. 5 shows a payout table concerning winning combinations and payout numbers for the respective winning combinations in the slot machine according to the first embodiment;

FIG. 6 shows a symbol lottery table A that is used for a base game at a payout rate of 85%;

FIG. 7 shows a symbol lottery table B that is used for a base game at a payout rate of 90%;

FIG. 8 shows a symbol lottery table C that is used for a base game at a payout rate of 95%;

FIG. 9 shows a symbol lottery table D that is used for a bonus game at a payout rate of 85%;

FIG. 10 shows a symbol lottery table E that is used for a bonus game at a payout rate of 90%;

FIG. 11 shows a symbol lottery table F that is used for a bonus game at a payout rate of 95%;

FIG. 12 is for explaining kinds of symbol lottery tables that are used based on payout rates set in the slot machine according to the first embodiment;

FIG. 13 shows a bonus game proceeding lottery table;

FIG. 14 is a flowchart showing a main control processing program in the slot machine according to the first embodiment;

FIG. 15 is a flowchart showing a main game processing program in the slot machine according to the first embodiment;

FIG. 16 is a flowchart showing a bonus game processing program in the slot machine according to the first embodiment;

FIG. 17 is for explaining payout rates and timings of changing the payout rates, in a slot machine according to a second embodiment;

FIG. 18 is a flowchart showing a main game processing program in the slot machine according to the second embodiment;

FIG. 19 is for explaining payout rates and timings of changing the payout rates, in a slot machine according to a third embodiment;

FIG. 20 is a flowchart showing a main game processing program in the slot machine according to the third embodiment;

FIG. 21 is for explaining payout rates and timings of changing the payout rates, in a slot machine according to a fourth embodiment;

FIG. 22 is a flowchart showing a main game processing program in the slot machine according to the fourth embodiment;

FIG. 23 is for explaining payout rates and timings of changing the payout rates, in a slot machine according to a fifth embodiment;

FIG. 24 is a flowchart showing a main game processing program in the slot machine according to the fifth embodiment;

FIG. 25 is for explaining payout rates and timings of changing the payout rates, in a slot machine according to a sixth embodiment; and

FIG. 26 is a flowchart showing a main game processing program in the slot machine according to the sixth embodiment.

### DESCRIPTION OF THE PREFERRED EMBODIMENTS

In the following, first to sixth embodiments of a gaming machine according to the present invention will be described in detail with reference to the accompanying drawings. In the first to sixth embodiment, the gaming machine according to the present invention is specified as a slot machine.

### First Embodiment

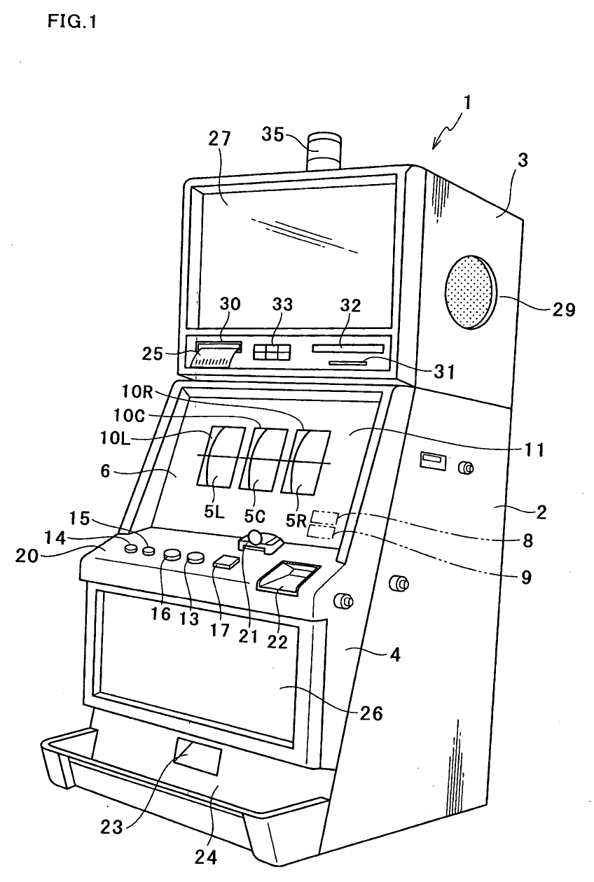

First, a schematic structure of a slot machine 1 according to a first embodiment will be described with reference to FIG. 1. FIG. 1 is a perspective view showing an appearance of a slot machine according to the first embodiment.

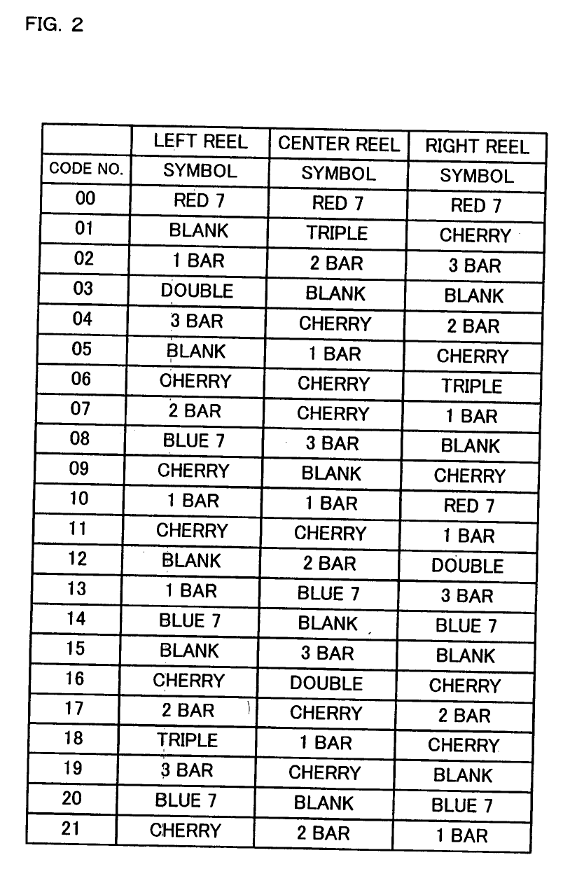

The slot machine 1 of the first embodiment includes a cabinet 2, a top box 3 placed on an upper side of the cabinet 2, and a main door 4 provided on a front face of the cabinet 2. Inside the cabinet 2, three rotatable reels 5L, 5C, and 5R are provided. A column of symbols, which includes twenty-two symbols (see FIG. 2), is painted on an outer surface of each of the reels 5L, 5C, and 5R.

On the main door 4, a lower image display panel 6 is provided in front of the reels 5L, 5C, and 5R. The lower image display panel 6 is made up of a known transparent liquid crystal panel. During a base game and a bonus game, the lower image display panel 6 makes display windows 10L, 10C, and 10R transparent so that symbols painted on the respective reels 5L, 5C, and 5R become visible. The lower image display panel 6 has, on its front face, a touch panel 11. A player inputs various commands by operating the touch panel 11.

The lower image display panel 6 further has a credit value indicator 8 and a payout number indicator 9. A credit value a player currently holds is indicated in the credit value indicator 8. A payout number which will be given on condition that a predetermined combination of symbols is stopped on a payline L or a payout number acquired in a bonus game is indicated in the payout number indicator 9.

Three display windows 10L, 10C, and 10R, through which their rear side can be seen, are formed in the lower image display panel 6. Three of the symbols painted on the outer surface of each of the reels 5L, 5C, and 5R can be seen through each of the display windows 10L, 10C, and 10R. One payline L is formed on the lower display panel 6. The payline L horizontally extends across the three display windows 10L, 10C, and 10R. The payline L defines a combination of symbols. When a predetermined combination of symbols is stopped on the payline L, a payout corresponding to the combination and to a betted credit value, i.e., a bet value, is given.

A control panel 20, a coin reception slot 21, and a bill discriminator 22 are provided on a lower side of the lower image display panel 6. The control panel 20 has buttons for a player to press in order to input commands concerning a game progress. The coin reception slot 21 receives a coin, which functions as a game medium, into the cabinet 2.

A SPIN button 13, an EXCHANGE button 14, a CASHOUT button 15, a 1-BET button 16, and a MAX-BET button 17 are provided on the control panel 20. The SPIN button 13 is an operation means for inputting a command to start rotation of the reels 5L, 5C, and 5R. The EXCHANGE button 14 is an operation means for asking a staff of a game arcade for an exchange. The CASHOUT button 15 is an operation means for inputting a command to pay out coins, the number of which is equivalent to a credit value a player holds, through a coin payout opening 23 into a coin tray 24, or for inputting a command to pay out in the form of a later-described barcoded ticket 25. Here, one credit is equivalent to one coin.

The 1-BET button 16 is an operation means for accepting a command to bet on a game one credit among a credit value a player holds. The MAX-BET button 17 is an operation means for accepting a command to bet on a game a maximum credit value bettable on one game among a credit value a player holds. In the first embodiment, the maximum credit value bettable on one game is 50 credits.

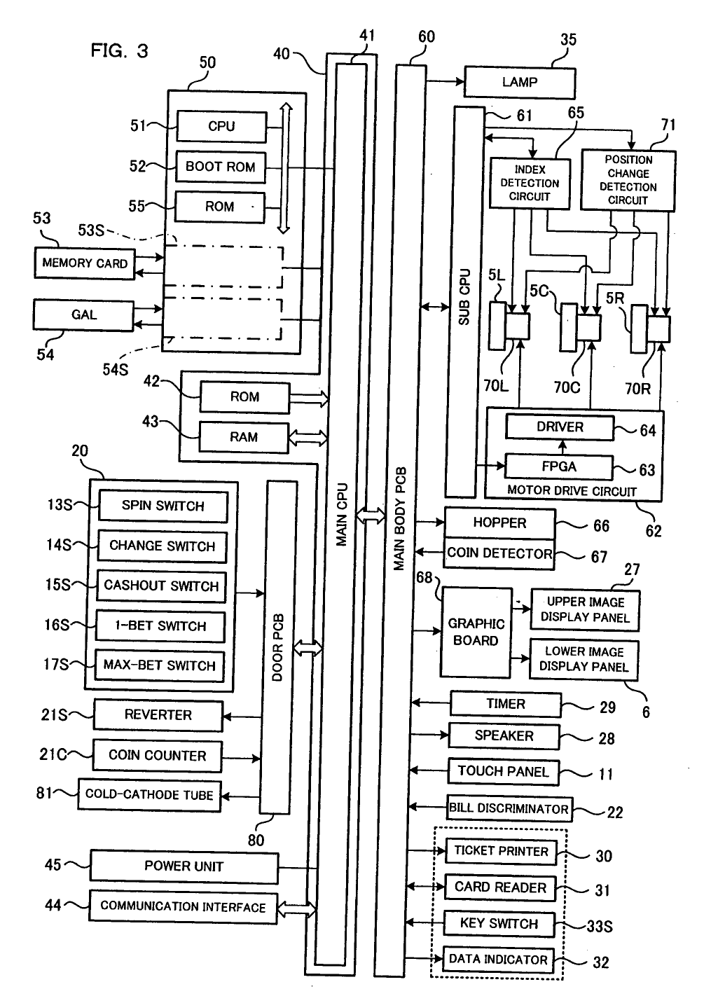

A reverter 21S and a coin counter 21C (see FIG. 3) are provided inside the coin reception slot 21. The reverter 21S determines whether a coin inserted into the coin reception slot 21 is proper one or not. Any coin different from a proper coin is ejected from the coin payout opening 23. The coin counter 21C detects a proper coin thus admitted, and counts the number of the coins.

The bill discriminator 22 determines whether a bill is proper one or not, and admits proper one into the cabinet 2. The bill inserted into the cabinet 2 is converted into coins, and a credit equivalent to the number of coins thus converted is added to the credit value a player holds. The bill discriminator 22 is adapted to read a barcoded thicket 25 which will be described later. A belly glass 26 on which a character of the slot machine 1 or the like is painted is provided on a lower part of the front face of the main door 4, that is, provided below the control panel 20.

In the slot machine 1 of the first embodiment, a coin, a bill, or valuable electronic information (credit) equivalent to them is adopted as a game medium. However, a game medium adoptable in the present invention is not limited thereto. For example, a medal, a token, electronic money, a ticket, and the like may be adopted.

An upper image display panel 27 is provided on a front face of the top box 3. The upper image display panel 27 has a liquid crystal panel, and displays thereon, for example, game information such as a currently-accumulated jackpot amount, illustration of game contents, and the like. A speaker 28 that outputs a sound is provided on a side face of the top box 3.

A ticket printer 30, a card reader 31, a data indicator 32, and a keypad 33 are provided on a lower side of the upper image display panel 27. The ticket printer 30 is a printing device that prints on a ticket a barcode showing, in a coded form, data such as a credit value, time and date, and an identification number of the slot machine 1, and outputs a barcoded ticket 25 thus printed. A player makes another gaming machine read the barcoded ticket 25 thus outputted, to play a game in the gaming machine. Also, a player uses the barcoded ticket 25 in order to take a procedure at a predetermined section of the game arcade.

The card reader 31 reads data out of a smart card and writes data into the smart card. The smart card is carried by a player, and stores therein data about history of games the player has played, for example.

The data indicator 32 is formed of a fluorescent display or the like. For example, data read out by the card reader 31, data inputted by a player through the keypad 33, or the like are indicated on the data indicator 32. The keypad 33 is operated for inputting data or a command about a ticket issuance. A lamp 35 is provided on an upper face of the top box 3. When a staff of a game arcade should be called, such as when an error occurs in the slot machine 1, the lamp 35 lights in a predetermined lighting pattern.

Subsequently, with reference to FIG. 2, a description will be given to symbols painted on the outer surfaces of the respective reels 5L, 5C, 5R, which are, during a game, variably displayed in a scrolling manner through the display windows 10L, 10C, and 10R of the lower image display panel 6. FIG. 2 schematically shows columns of symbols that are painted on outer surfaces of respective reels 5L, 5C, and 5R.

Twenty-two symbols are painted on the outer surface of each of the left reel 5L, the center reel 5C, and the right reel 5R. Each column of the symbols is a combination of symbols of “TRIPLE”, “DOUBLE”, “RED 7”, “BLUE 7”, “3 BAR”, “2 BAR”, “1 BAR”, and “CHERRY”. As shown in FIG. 2, on the surface of each of the reels 5L, 5C, and 5R, predetermined symbols including “BLANK” are arranged in a predetermined order.

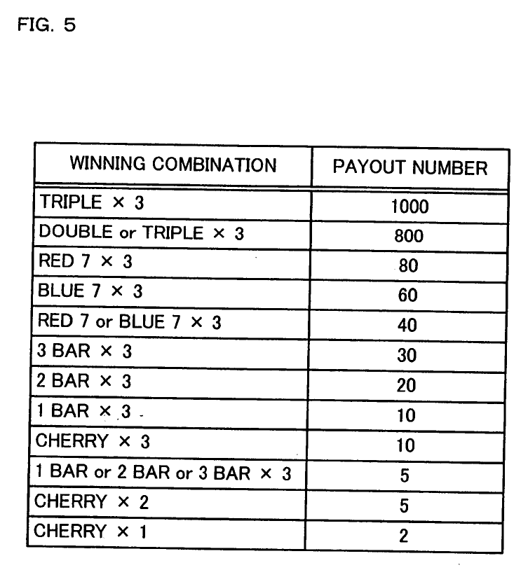

When three “RED 7” symbols, three “BLUE 7” symbols, three “3 BAR” symbols, three “2 BAR” symbols, three “1 BAR” symbols, or three “CHERRY” symbols are stopped on the payline L, a predetermined payout is given to a player (see FIG. 5). Also when one or two “CHERRY” symbols are stopped on the payline L, a predetermined payout is given to a player in accordance with the number of “CHERRY” symbols stopped (see FIG. 5).

When the 1-BET button 16 or the MAX-BET button 17 is operated to fix a bet value and then the SPIN button 13 is operated, the columns of symbols painted on the reels 5L, 5C, and 5R as shown in FIG. 2 are, along with rotation of the reels 5L, 5C, 5R, displayed scrollingly from up to down within the display windows 10L, 10C, and 10R, respectively. After a predetermined period of time elapses, the reels 5L, 5C, and 5R stop rotating. As rotation of the reels 5L, 5C, and 5R stops, the columns of symbols painted on the reels 5L, 5C, and 5R are stopped in the display windows 10L, 10C, and 10R, respectively. Various wins have been preset based on combinations of symbols (see FIG. 5). When a certain combination of symbols that corresponds to a win is stopped on the payline L, a payout associated with the win is given to a player.

The “TRIPLE” symbol and the “DOUBLE” symbol are so-called WILD symbols that can be substituted for another symbols, that is, for the “RED 7” symbol, the “BLUE 7” symbol, the “3 BAR” symbol, the “2 BAR” symbol, the “1 BAR” symbol, or the “CHERRY” symbol. In addition, when a winning combination including the “TRIPLE” symbol is made, three times a payout is given. When a winning combination including the “DOUBLE” symbol is made, twice a payout is given. When a winning combination including two of the “DOUBLE” and “TRIPLE” symbols is made, four times, six times, or nine times a payout is given in accordance with the combination made.

Further, in the slot machine 1 of the first embodiment, an internal lottery for proceeding to a bonus game, which is independent of a lottery for determining stopped symbols, is held in every game. When an internal lottery for proceeding to a bonus game is won, a bonus game (which is a so-called mystery bonus game) occurs upon stopping of the reels 5L, 5C, and 5R, irrespective of a combination of symbols on the payline. Here, a bonus game played on the slot machine 1 of the first embodiment is a so-called free game in which, without using a credit, the reels 5L, 5C, and 5R consecutively rotate at predetermined times. Details of the bonus game will be described later.

Next, a control system of the slot machine 1 of the first embodiment will be described with reference to FIG. 3. FIG. 3 is a block diagram schematically showing a control system of the slot machine 1 of the first embodiment.

As shown in FIG. 3, a control system of the slot machine 1 basically has a mother board 40 and a gaming board 50.

The gaming board 50 will firstly be described. The gaming board 50 includes a CPU 51, a ROM 55, a boot ROM 52, a card slot 53S, and an IC socket 54S. The CPU 51, the ROM 55, and the boot ROM 52 are connected to each other via an internal bus. The card slot 53S corresponds to a memory card 53. The IC socket 54S corresponds to a GAL (General Array Logic) 54.

The memory card 53 is a non-volatile memory, and a recording medium in which a game program and a game system program (hereinafter referred to as a game program and the like) are recorded. The game program recorded in the memory card 53 includes a lottery program. The lottery program is a program for determining a symbol (and more specifically a code number associated with a symbol) in each of the reels 5L, 5C, and 5R which will be stopped on the payline L.

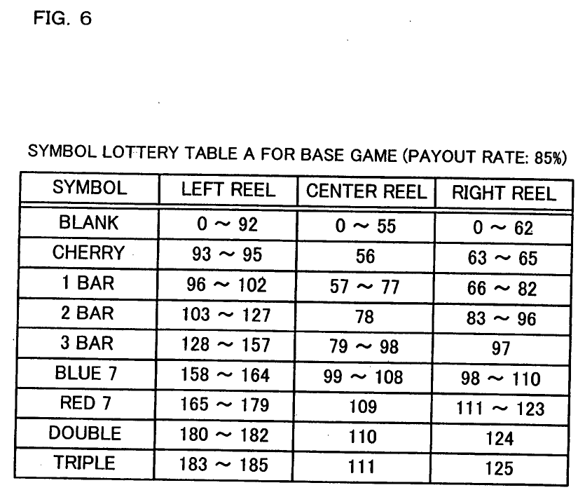

The memory card 53 includes symbol lottery tables (see FIGS. 6 to 11) for a base game and a bonus game. The symbol lottery tables correspond respectively to several kinds of payout rates (in the first embodiment for example, there are three kinds payout rates, 85%, 90%, and 95%) that are changed and set at a predetermined timing in the slot machine 1. Here, the symbol lottery table is a table indicating, with respect to each of the three reels 5L, 5C, and 5R, a correspondence between each symbol and one or more random numbers belonging to a predetermined random number range (which means a range “0-185” for the reel 5L, a range “0-111” for the reel 5C, and a range “0-125” for the reel 5R). That is, one symbol corresponds to one or more random numbers. A random number is sampled by a lottery processing, and a symbol identified by the sampled random number is stopped. The symbol lottery table will be detailed later.

A payout rate set in the slot machine 1 is determined based on payout rate setting data which is outputted from the GAL 54 inserted by a game shop side. A lottery is held based on the symbol lottery table corresponding to this payout rate.

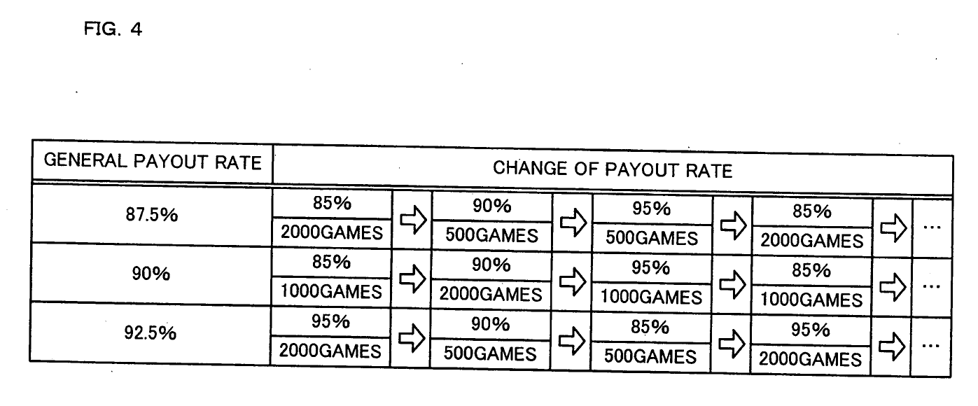

In the following, with reference to FIG. 4, a specific description will be given to a payout rate set in the slot machine 1 of the first embodiment. In the slot machine 1 of the first embodiment, the game shop side sets a general payout rate at any of 87.5%, 90%, and 92.5%, based on payout rate setting data outputted from the GAL 54. Here, the general payout rate can be arbitrarily set by the game shop side, as long as it satisfies a standard in a country or region where the slot machine 1 is placed.

A main CPU 41 sequentially changes a payout rate at a predetermined timing in accordance with the general payout rate and the number of games played. For example, when the general payout rate is set at 87.5%, a payout rate is firstly set at 85% and in this condition 2000 games are played. Then, the payout rate is changed from 85% to 90%, and 500 games are played in a condition that the payout rate is 90%. Then, the payout rate is changed from 90% to 95%, and 500 games are played in a condition that the payout rate is 95%. Then, the payout rate is returned to 85% again, and thus the above-described cycle is repeated. Consequently, even though a payout rate is changed within a range of 85% to 95%, a general payout rate throughout the game is kept at 87.5%.

When the general payout rate is set at 90%, a payout rate is firstly set at 85% and in this condition 1000 games are played. Then, the payout rate is changed from 85% to 90%, and 2000 games are played in a condition that the payout rate is 90%. Then, the payout rate is changed from 90% to 95%, and 1000 games are played in a condition that the payout rate is 95%. Then, the payout rate is returned to 85% again, and thus the above-described cycle is repeated. Consequently, even though a payout rate is changed within a range of 85% to 95%, a general payout rate throughout the game is kept at 90%.

When the general payout rate is set at 92.5%, a payout rate is firstly set at 95% and in this condition 2000 games are played. Then, the payout rate is changed from 95% to 90%, and 500 games are played in a condition that the payout rate is 90%. Then, the payout rate is changed from 90% to 85%, and 500 games are played in a condition that the payout rate is 85%. Then, the payout rate is returned to 95% again, and thus the above-described cycle is repeated. Consequently, even though a payout rate is changed within a range of 85% to 95%, a general payout rate throughout the game is kept at 92.5%.

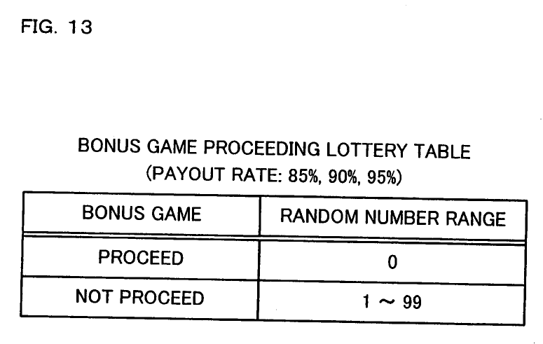

The memory card 53 also includes a bonus game proceeding lottery table (see FIG. 13) for determining whether or not to proceed to a bonus game after a base game is finished. The bonus game proceeding lottery table is a table indicating a correspondence between a determination on proceeding to a bonus game and one or more random numbers belonging to a predetermined random number range (0 to 99). The bonus game proceeding lottery table will be detailed later.

The memory card 53 can be inserted into and pulled out of the card slot 53S, and the card slot 53S is connected to the mother board 40 via an IDE bus. By rewriting a game program and the like stored in the memory card 53, a kind of game or contents of a game playable in the slot machine 1 can be changed. Alternatively, by replacing the memory card 53 with another memory card 53 in which another game program and the like are stored, a kind of game or contents of a game playable in the slot machine 1 can be changed.

The game program includes a program concerning a game progress, image data and sound data which are outputted during a game, image data and sound data serving as notification data, and the like.

The GAL 54 is a kind of PLD having a fixed-OR logic array. The GAL 54 has input ports and output ports. When predetermined data is inputted into the input ports, the GAL 54 outputs from the output ports data corresponding to the inputted data. The above-mentioned payout rate setting data is outputted from the output ports.

The GAL 54 can be inserted into and pulled out of the IC socket 54S, and the IC socket 54S is connected to the mother board 40 via a PCI bus. By rewriting the GAL 54 or replacing the GAL 54 itself, a payout rate setting data outputted from the GAL 54 can be changed.

The CPU 51, the ROM 55, and the boot ROM 52, which are connected to each other via the internal bus, are connected to the mother board 40 via a PCI bus. The PCI bus carries a signal between the mother board 40 and the gaming board 50, and besides supplies power from the mother board 40 to the gaming board 50. Country identification information and an authentication program are stored in the ROM 55. A preliminary authentication program, a program for the CPU 51 to boot up the preliminary authentication program, which means a boot code, and the like are stored in the boot ROM 52.

The authentication program is a program for authenticating the game program and the like. That is, the authentication program is a falsification check program. The authentication program is written along a procedure of falsification check on a game program and the like targeted for an authentication capturing processing. The preliminary authentication program is a program for authenticating the authentication program. The preliminary authentication program is written along a procedure of falsification check on an authentication program targeted for an authentication processing.

Next, the mother board 40 will be described. The mother board 40 is formed using a general-purpose mother board on the market, that is, a printed wiring board mounted with basic components of a personal computer. The mother board 40 has a main CPU 41, a ROM 42, a RAM 43, and a communication interface 44.

The ROM 42 has a memory device such as a flash memory. A program such as a BIOS, which is executed by the main CPU 41, and permanent data such as a payout table for a base game (see FIG. 5) are stored in the ROM 42. When the main CPU 41 executes the BIOS, predetermined peripheral units are subjected to an initialization process, and capturing of a game program and the like that are stored in the memory card 53 is started via the gaming board 50.

Data and a program, which are used in operations of the main CPU 41, are stored in the RAM 43. The RAM 43 can store therein various programs such as the authentication program, the game program and the like which are read out of the gaming board 50, and various information such as a credit value a player currently holds, the number of games played and the like.

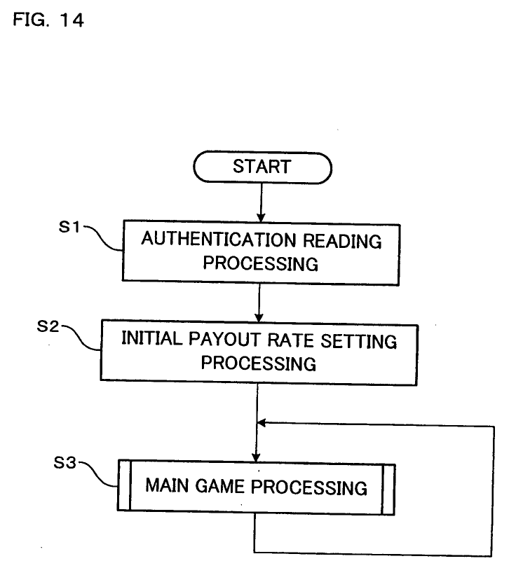

The communication interface 44 is a communication device that communicates through a communication line with a server and the like placed in the game arcade. In a later-described main game processing (see S3 in FIG. 14), the slot machine 1 communicates bet information, a lottery result of a basic lottery processing and the like, with the server and the like through the communication interface 44.

A main body PCB 60 and a door PCB 80 which will be described later are respectively connected to the mother board 40 via USBs. A power unit 45 is also connected to the mother board 40. When power is supplied from the power unit 45 to the mother board 40, the main CPU 41 of the mother board 40 is started, and power is supplied through the PCI bus to the gaming board 50 so that the CPU 51 is started.

Equipments or devices that generate an input signal to be inputted to the main CPU 41, and equipments or devices whose operations are controlled in accordance with a control signal from the main CPU 41 are connected to the main body PCB 60 and the door PCB 80. Based on an input signal inputted into the main CPU 41, the main CPU 41 executes the game program and the like stored in the RAM 43. Then, the main CPU 41 executes a predetermined computing processing, to thereby store a result of the computing processing into the RAM 43 or execute a controlling processing on respective equipments or devices.

A lamp 35, a sub CPU 61, a hopper 66, a coin detector 67, a graphic board 68, a speaker 28, a timer 29, a touch panel 11, a bill discriminator 22, a ticket printer 30, a card reader 31, a key switch 33S, and a data indicator 32 are connected to the main body PCB 60.

Here, the timer 29 is a time measuring means having a calendar function. Time information of the timer 29 is transmitted to the main CPU 41. The main CPU 41 can detect not only current date, day of week, and a time of day, but also operation time having elapsed since the slot machine 1 starts operating.

The touch panel 11, which is provided on the front face of the lower image display panel 6, can identify a coordinate location of a player's contact point. Based on the coordinate location thus identified, the touch panel 11 can determine where a player touches and in which direction a touched point moves.

The sub CPU 61 controls rotating and stopping of the reels 5L, 5C, and 5R. A motor drive circuit 62 including an FPGA (Field Programmable Gate Array) 63 and the driver 64 is connected to the sub CPU 61. The FPGA 63 is an electronic circuit such as an LSI capable of programming. The FPGA 63 functions as a control circuit for stepping motors 70L, 70C, and 70R. The driver 64 functions as an amplifier circuit for a pulse which will be inputted into the stepping motors 70L, 70C, and 70R. The stepping motors 70L, 70C, and 70R are connected to the motor drive circuit 62. The stepping motors 70L, 70C, and 70R are for rotating the respective reels 5L, 5C, and 5R. The stepping motors 70L, 70C, and 70R are stepping motors of 1-2 phase excitation type.

An index detection circuit 65 and a position change detection circuit 71 are connected to the sub CPU 61. The index detection circuit 65 detects a position, e.g., a reference point, of the rotating reels 5L, 5C, and 5R, and in addition detects out-of-step of the reels 5L, 5C, and 5R.

The position change detection circuit 71 detects a change of a stopping position of the reels 5L, 5C, and 5R after rotation of the reels 5L, 5C, and 5R is stopped. For example, in a case where a winning combination of symbols is actually not made but nevertheless a player forcibly changes a stopping position so as to make a winning combination of symbols, the position change detection circuit 71 detects a change of a stopping position of the reels 5L, 5C, and 5R.

The hopper 66 is placed within the cabinet 2, and pays out a predetermined number of coins through the coin payout opening 23 into the coin tray 24 based on a control signal from the main CPU 41. The coin sensor 67 is provided inside the coin payout opening 23, and outputs an input signal into the main CPU 41 when detecting a predetermined number of coins being paid out through the coin payout opening 23.

The graphic board 68 controls an image display on the upper image display panel 27 and the lower image display panel 6, based on a control signal from the main CPU 41. For example, the credit value indicator 8 indicates a credit value a player holds, which is stored in the RAM 43. The payout number indicator 9 indicates a number of credits to be paid out by a payout number.

The graphic board 68 has a VDP (Video Display Processor), a video RAM, and the like. The VDP generates image data based on a control signal from the main CPU 41. Image data generated by the VDP is temporarily stored in the video RAM. Image data used by the VDP in generating image data is included in the game program.

The bill discriminator 22 determines whether a bill or a barcoded ticket 25 is proper one or not, and admits a proper bill or a proper barcoded ticket 25 into the cabinet 2. When admitting a proper bill, the bill discriminator 22 outputs an input signal to the main CPU 41 based on an amount of the bill. Also, the bill discriminator 22 outputs an input signal to the main CPU 41 based on the number of coins recorded on a proper barcoded ticket 25.

Based on a control signal outputted from the main CPU 41, the ticket printer 30 prints on a ticket a barcode showing, in a coded form, data such as a credit value stored in the RAM 43, and outputs a barcoded ticket 25 thus printed.

The card reader 31 reads data out of a smart card and transmits the data to the main CPU 41, or writes data into a smart card based on a control signal from the main CPU 41. The key switch 33S is provided in the keypad 33. When the keypad 33 is operated by a player, the key switch 33S outputs a predetermined input signal to the main CPU 41. Based on a control signal outputted from the main CPU 41, the data indicator 32 indicates data read out by the card reader 31, data inputted by a player using the keypad 33, or the like.

The control panel 20, the reverter 21S, the coin counter 21C, and a cold-cathode tube 81 are connected to the door PCB 80. The control panel 20 includes a SPIN switch 13S corresponding to the SPIN button 13, an EXCHANGE switch 14S corresponding to the EXCHANGE button 14, a CASHOUT switch 15S corresponding to the CASHOUT button 15, a 1-BET switch 16S corresponding to the 1-BET button 16, and a MAX-BET switch 17S provided within the MAX-BET button 17. When a button corresponding to each switch is pressed by a player, the switch outputs an input signal to the main CPU 41.

The coin counter 21C, which is provided inside the coin reception slot 21, determines whether a coin inserted by a player into the coin reception slot 21 is proper one or not. Any coin different from a proper coin is ejected from the coin payout opening 23. When a proper coin is detected, the coin counter 21C outputs an input signal to the main CPU 41.

The reverter 21S operates based on a control signal outputted from the main CPU 41. The reverter 21S distributes a coin, which has been determined as proper by the coin counter 21C, to a cash box (not shown) provided in the slot machine 1 or to the hopper 66. The cold-cathode tube 81 is provided on a back side of the lower image display panel 6 and the upper image display panel 27. The cold-cathode tube 81 is lighted based on a control signal from the main CPU 41, and functions as a backlight.

Next, winning combinations and payouts therefor, which occur when a base game and a bonus game are played in the slot machine 1 of the first embodiment using the reels 5L, 5C, and 5R, will be described with reference to FIG. 5. FIG. 5 shows a payout table indicating winning combinations, probabilities of the respective winning combinations, and payout numbers for the respective winning combinations, which occur when a game is played using the reels 5L, 5C, and 5R.

Here, payout numbers shown in FIG. 5 are under the condition that a bet value is “1”. Accordingly, when a bet value is “1”, the payout number shown in FIG. 5 is added to a credit value. When a bet value is “2” or larger, a value obtained by multiplying the payout number shown in FIG. 5 by the bet value is added to a credit value.

For example, when three “TRIPLE” symbols are stopped on the payline L, 1000 credits are paid out as a payout.

When three symbols including a combination of “DOUBLE” and “TRIPLE” symbols are stopped on the payline L, 800 credits are paid out as a payout.

When three “RED 7” symbols are stopped on the payline L, 80 credits are paid out as a payout.

Likewise, a payout is set for every combination of symbols shown in FIG. 5. When a combination of symbols not shown in FIG. 5 is stopped, it means a loss and therefore no credit is paid out.

Next, with reference to FIGS. 6 to 11, a description will be given to a symbol lottery table that is used for determining which symbols will be stopped on the payline when a base game and a bonus game are executed in the slot machine 1 of the first embodiment. Here, the symbol lottery table is a table indicating, with respect to each of the three reels 5L, 5C, and 5R, a correspondence between each symbol and one or more random numbers belonging to a predetermined random number range (which means a range “0-185” for the reel 5L, a range “0-111” for the reel 5C, and a range “0-125” for the reel 5R). Based on a sampled random number and the symbol lottery table, the main CPU 41 determines which symbol will be stopped on the payline L.

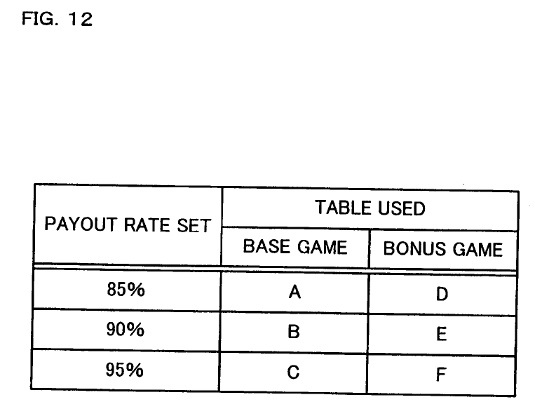

The symbol lottery table used in the slot machine 1 of the first embodiment has six kinds of symbol lottery tables A to F in total. As shown in FIG. 12, for every one of three payout rates, 85%, 90%, and 95%, which table should be used is determined beforehand. The three payout rates, 85%, 90%, and 95% are set based on a general payout rate and the number of games played (see FIG. 4).

First, FIG. 6 shows a symbol lottery table A that is used for a base game at a payout rate of 85%. According to the symbol lottery table A, when for example a random number sampled for the left reel 5L is in a range of “0 to 92”, the “BLANK” symbol is stopped on the payline L. When a random number sampled is in a range of “93 to 95”, the “CHERRY” symbol is stopped on the payline L. Likewise, for the “1 BAR” symbol, “2 BAR” symbol, “3 BAR” symbol, “BLUE 7” symbol, “RED 7” symbol, “DOUBLE” symbol, and “TRIPLE” symbol, respective random number ranges are set. With respect to the center reel 5C and the right reel 5R as well, a random number range is set for each symbol in the same manner.

In a base game played using the symbol lottery table A, an expected value of a payout rate is 85.192%.

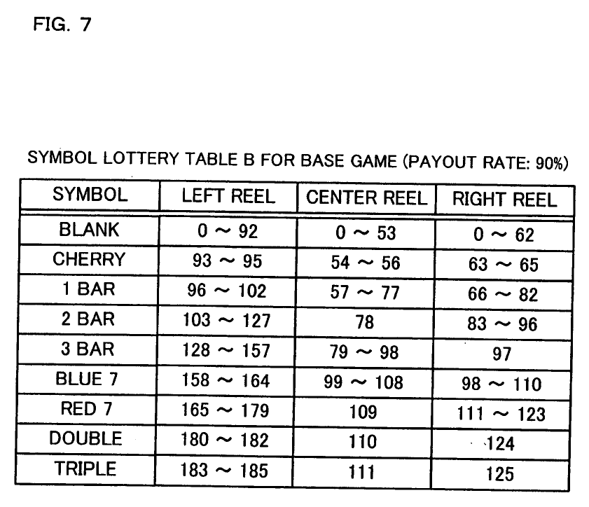

FIG. 7 shows a symbol lottery table B that is used for a base game at a payout rate of 90%. In the symbol lottery table B, with respect to the left reel 5L, the center reel 5C and the right reel 5R, a predetermined random number range is set for each symbol, as shown in FIG. 7. In a base game played using the symbol lottery table B, an expected value of a payout rate is 89.773%.

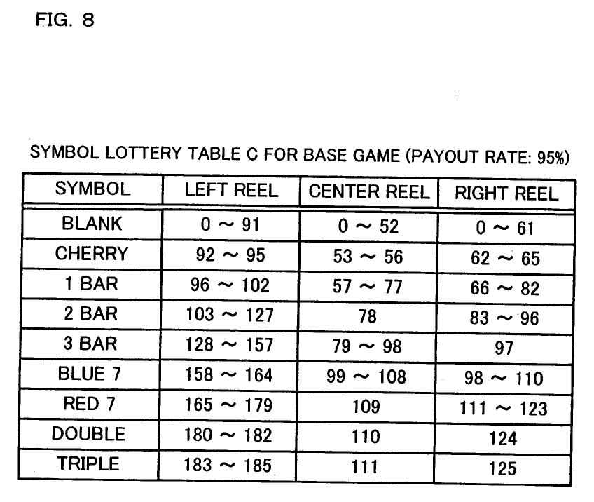

FIG. 8 shows a symbol lottery table C that is used for a base game at a payout rate of 95%. In the symbol lottery table C, with respect to the left reel 5L, the center reel 5C and the right reel 5R, a predetermined random number range is set for each symbol, as shown in FIG. 8. In a base game played using the symbol lottery table C, an expected value of a payout rate is 95.434%.

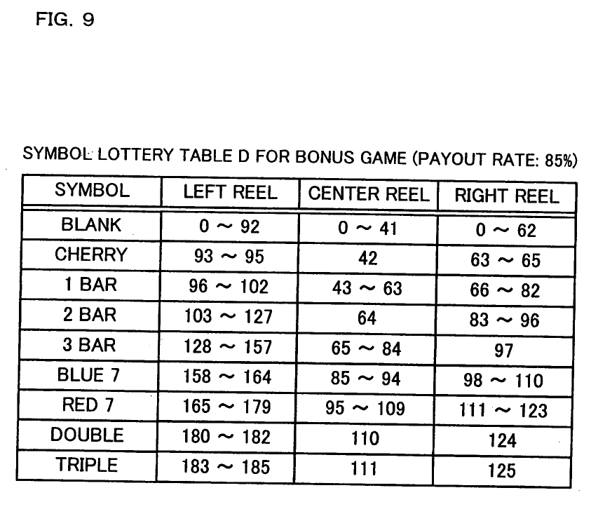

FIG. 9 shows a symbol lottery table D that is used for a bonus game at a payout rate of 85%. In the symbol lottery table D, with respect to the left reel 5L, the center reel 5C and the right reel 5R, a predetermined random number range is set for each symbol, as shown in FIG. 9. In a bonus game played using the symbol lottery table D, an expected value of a payout rate is 121.184%.

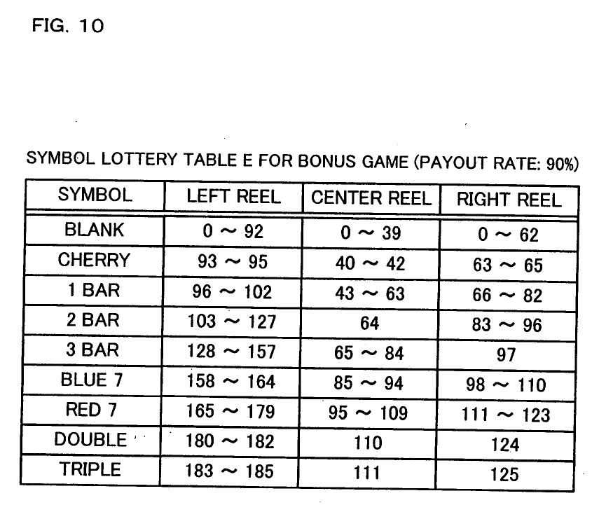

FIG. 10 shows a symbol lottery table E that is used for a bonus game at a payout rate of 90%. In the symbol lottery table E, with respect to the left reel 5L, the center reel 5C and the right reel 5R, a predetermined random number range is set for each symbol, as shown in FIG. 10. In a bonus game played using the symbol lottery table E, an expected value of a payout rate is 125.764%.

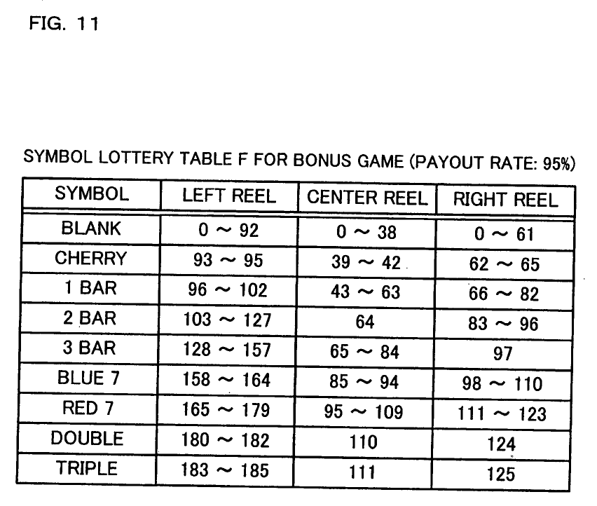

FIG. 11 shows a symbol lottery table F that is used for a bonus game at a payout rate of 95%. In the symbol lottery table F, with respect to the left reel 5L, the center reel 5C and the right reel 5R, a predetermined random number range is set for each symbol, as shown in FIG. 11. In a bonus game played using the symbol lottery table F, an expected value of a payout rate is 131.426%.

Next, a description will be given to the bonus game proceeding lottery table that is used for determining by lottery whether or not to proceed to a bonus game in the slot machine 1 of the first embodiment. FIG. 13 shows the bonus game proceeding lottery table.

As shown in FIG. 13, the bonus game proceeding lottery table is a table indicating a correspondence between a determination on proceeding to a bonus game and a predetermined random number range (0 to 99). When the SPIN button 13 is pressed by a player, the main CPU 41 samples a random number from the range of “0 to 99”, and determines whether or not to proceed to a bonus game after a base game is finished. When a sampled random number is “0” for example, a bonus game is won. Thus, after a base game is finished, a game proceeds to a bonus game including a free game. When a sampled random number is in a range of “1 to 99”, a game ends without proceeding to a bonus game.

Here, in the slot machine 1 of the first embodiment, the same bonus game proceeding lottery table is used irrespective of a payout number (which are of three kinds, 85%, 90%, and 95%) set in the slot machine 1. However, tables presenting different proceeding probabilities may be prepared for the three respective payout rates.

Next, a main control program that is executed in the slot machine 1 of the first embodiment will be described in detail with reference to the drawings. FIG. 14 is a flowchart showing a main control program.

It is presupposed that, in the slot machine 1, the memory card 53 has already been inserted into the card slot 53S of the gaming board 50 and the GAL 54 has already been mounted to the IC socket 54S.

First, when a power switch of the power unit 45 is turned on, that is, when the power unit 45 is powered up, the mother board 40 and the gaming board 50 are respectively booted up, and an authentication reading processing step (hereinafter abbreviated as S) 1 is executed. In the authentication reading processing, the mother board 40 and the gaming board 50 concurrently execute different processings.

To be more specific, in the gaming board 50, the CPU 51 reads out the preliminary authentication program that is stored in the boot ROM 52. In accordance with the preliminary authentication program thus read out, the CPU 51 performs a preliminary authentication for checking and proving that the authentication program is not falsified, before the mother board 40 captures the authentication program.

In the mother board 40, on the other hand, the main CPU 41 executes the BIOS that is stored in the ROM 42, and expands in the RAM 43 compressed data included in the BIOS. The main CPU 41 executes the BIOS thus expanded in the RAM 43. The main CPU 41 also checks and initializes various peripheral units.

Then, the main CPU 41 reads out the authentication program stored in the ROM 55, and performs an authentication for checking and proving that a game program and the like stored in the memory card 53 that is inserted into the card slot 53S are not falsified. When the authentication processing is completed normally, the main CPU 41 stores into the RAM 43 the game program and the like thus authenticated, and acquires payout rate setting data and country identification information.

After executing the above-described processing, the main CPU 41 completes the authentication reading processing.

In S2, the main CPU 41 sets a general payout rate at any of 87.5%, 90%, and 92.5%, based on the payout rate setting data outputted from the GAL 54. Then, in accordance with the general payout rate thus set, the main CPU 41 sets an initial payout rate. For example, when the general payout rate is set at 87.5%, the main CPU 41 firstly sets the initial payout rate at 85%. When the general payout rate is set at 90%, the main CPU 41 sets the initial payout rate at 85%. When the general payout rate is set at 92.5%, the main CPU 41 sets the initial payout rate at 95% (see FIG. 4). When a predetermined condition is satisfied, the initial payout rate set in S2 is changed to another payout rate. In the first embodiment, the predetermined condition is that the number of games played reaches a predetermined number.

In S3, the main CPU 41 sequentially reads out of the RAM 43 the game program and the like that have been authenticated in the authentication reading processing S1. The main CPU 41 executes these programs, to execute a main game processing. By executing the main game processing, a game is played in the slot machine 1 of the first embodiment. The main game processing is executed repeatedly as long as the slot machine 1 is supplied with power.

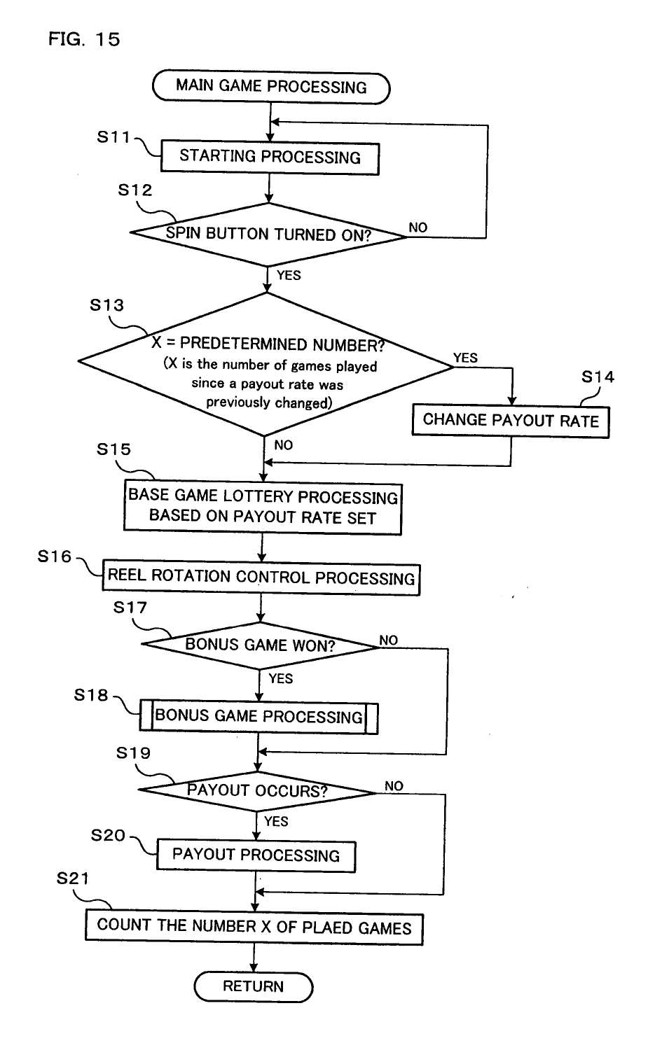

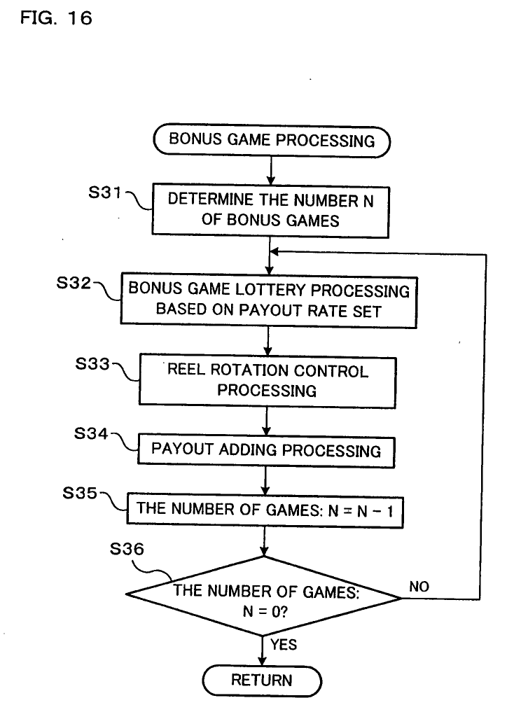

Next, a sub processing in the main game processing S3 will be described with reference to FIG. 15. FIG. 15 is a flowchart showing a main game processing program in the slot machine 1 of the first embodiment. Here, programs shown by flowcharts in FIGS. 15 and 16 are stored in the memory card 53, expanded in the RAM 43 of the slot machine 1, and executed by the main CPU 41.

As shown in FIG. 15, the main CPU 41 firstly executes a predetermined initial setting. Then, the main CPU 41 executes a starting processing for setting a coin insertion, a bet value betted on the payline L, and the like (S11). In this starting processing, a player performs a betting operation by inserting a coin or using the 1-BET button 16 or the MAX-BET button 17.

Then, in S12, the main CPU 41 determines whether the SPIN button 13 is inputted or not. Here, whether the SPIN button 13 is inputted or not is determined based on whether an input signal is received from the SPIN switch 13S or not.

When the SPIN button 13 is not inputted (S12: NO), the processing returns to the starting processing S11 again. At this time, operations such as changing a bet value can be made. When the SPIN button 13 is inputted (S12: YES), the main CPU 41 subtracts from the current credit value a bet value that has been set on the payline L based on operation of the 1-BET button 16 or the MAX-BET button 17. Then, the main CPU 41 stores the bet value into the RAM 43 as bet data.

Subsequently, in S13, the main CPU 41 determines whether the number X of games that have been played since the payout rate was previously changed (S14) or since the initial payout rate was set (S2) reaches a predetermined number or not. When it is determined that the number X reaches the predetermined number (S13: YES), the main CPU 41 changes the set payout rate (S14). When it is determined that the number X does not reach the predetermined number (S13: NO), the processing proceeds to S15.

Here, in the slot machine 1 of the first embodiment, the payout number is sequentially changed at a predetermined timing, in accordance with the number of games played (except for bonus games) and the general payout rate set at any of 87.5%, 90%, 92.5%, as shown in FIG. 4.

For example, in a case where the general payout rate is set at 87.5%, the payout rate is changed from 85% to 90% in a condition that 2000 games have been played since the payout rate is set at 85%. In a condition that 500 games have been played since the payout rate is set at 90%, the payout rate is changed from 90% to 95%. Then, in a condition that 500 games have been played since the payout rate is set at 95%, the payout rate is changed from 95% to 85%. That is, the main CPU 41 executes a game based on a first payout rate (e.g., 85%), and stores a numerical value that is updated along with execution of the game. In a case where the stored numerical value becomes a certain numerical value (e.g., 2000) associated with the first payout rate beforehand, the main CPU 41 executes the game based on a second payout rate (e.g., 90%) that is different from the first payout rate. Here, the main CPU 41 may be connected so as to control the upper image display panel 27 and the lower image display panel 6.

In addition, it may be possible that, until the stored numerical value becomes a certain numerical value (e.g., 500) associated with the second payout rate beforehand, the main CPU 41 executes the game based on the second payout rate (e.g., 90%).

In addition, it may be possible that the certain numerical value (e.g., 2000) associated with the first payout rate beforehand and the certain numerical value (e.g., 500) associated with the second payout rate beforehand are set based on the general payout rate (e.g., 87.5%), the first payout rate (e.g., 85%), and the second payout rate (e.g., 90%).

Subsequently, in S15, the main CPU 41 executes a base game lottery processing using the reels 5L, 5C, and 5R. More specifically, the main CPU 41 executes a random number generating program that is included in the lottery program stored in the RAM 43, to thereby select, among a predetermined number range (a range “0-185” for the reel 5L, a range “0-111” for the reel 5C, and a range “0-125” for the reel 5R), a random number corresponding to each of the three reels 5L, 5C, and 5R. Then, the main CPU 41 refers to the symbol lottery table A to C corresponding to the payout rate that is set based on the number of games played, and determines code numbers for the respective reels 5L, 5C, and 5R (see FIG. 2) based on three random numbers selected. Here, the symbol lottery table A corresponds to the payout rate 85% (FIG. 6), the symbol lottery table B corresponds to the payout rate 90% (FIG. 7), and the symbol lottery table C corresponds to the payout rate 95% (FIG. 8). The code numbers thus determined for the respective reels 5L, 5C, and 5R are stored into the RAM 43, and then the processing proceeds to S16.

The code numbers for the respective reels 5L, 5C, and 5R correspond to code numbers of symbols which will be stopped on the payline L. Accordingly, by determining code numbers for the respective reels 5L, 5C, and 5R, the main CPU 41 determines a combination in the current game. For example, when code numbers for the respective reels 5L, 5C, and 5R are determined as “00”, “00”, and “00”, it means that the main CPU 41 determines a combination to be “RED 7”. Like this, by determining code numbers for the respective reels 5L, 5C, and 5R, a lottery occurs for a winning combination in a base game (see FIG. 5). A method for determining code numbers for the respective reels 5L, 5C, and 5R based on three random numbers selected is exemplified by one using a table that presents in advance correspondences such as the code number 01 BLANK for a random number “0 to 20”, the code number 05 BLANK for a random number “20 to 40”. Alternatively, it may also be possible to detect a stopping position of the reel in the lottery and adopt a code number closest to the stopping position.

In S15, moreover, a lottery is held for whether or not to proceed to a bonus game, too. By executing the random number generating program that is included in the lottery program stored in the RAM 43, the main CPU 41 selects a random number from the random number range “0-99” and determines, using the bonus game proceeding lottery table (FIG. 13), whether or not to proceed to a bonus game after the base game is finished.

Subsequently, in S16, the main CPU 41 executes a reel rotation control processing. In the reel rotation control processing, the main CPU 41 starts rotation of all the reels 5L, 5C, and 5R, and then stops the rotation of the respective reels 5L, 5C, and 5R so that a combination of symbols determined in the base game lottery processing S15 is stopped on the payline L. The reel rotation control processing is executed by the main CPU 41 and the sub CPU 61.

To be more specific, in the reel rotation control processing S16, the main CPU 41 firstly transmits to the sub CPU 61 a start signal for starting rotation of the reels 5L, 5C, and 5R. Upon receiving the start signal, the sub CPU 61 executes a reel rotation processing. That is, the sub CPU 61 drives the respective stepping motors 70L, 70C, and 70R through the motor drive circuit 62 and the driver 64, so that the reels 5L, 5C, and 5R start rotating.

After transmitting the start signal, the main CPU 41 determines an effect mode for one game (which means a mode of displaying an image on the lower image display panel 6, outputting sound from the speaker 28 or the like), and starts presenting effect in the determined mode. A timing of determining the effect mode can be appropriately set.

Then, when a predetermined timing of stopping the rotation of the reels 5L, 5C, and 5R comes, the main CPU 41 transmits to the sub CPU 61 the code numbers of the reels stored in the RAM 43. The sub CPU 61 stops the reels 5L, 5C, and 5R based on the code numbers of the reels. Consequently, symbols corresponding to the lottery result are stopped in the display windows 10L, 10C, and 10R on the payline L.

In S17, the main CPU 41 determines whether a bonus game has been won in the lottery processing S15 or not. When it is determined that a bonus game has been won (S17: YES), a bonus game processing S18 which will be described later is executed.

When it is determined that a bonus game trigger has not been made (S17: NO), the processing proceeds to S19.

In S19, the main CPU 41 determines whether there is a payout in this slot machine 1 or not. When there is a payout (S19: YES), the processing proceeds to S20. When there is no payout (S19: NO), the processing proceeds to S21.

In a case where a bonus game has not been played, a payout obtained in the base game (see FIG. 5) is paid out to the player in S20. In a case where a bonus game has been played, a payout obtained in the base game and a payout obtained in the bonus game are paid out to the player in S20. At this time, the CASHOUT button 15 may be pressed to pay out coins equivalent to the credit value (one coin for one credit), or alternatively a barcoded ticket 25 may be issued. It may be possible that, in a case where a bonus game has been won, the processing proceeds to the bonus game after a payout obtained in the base game is paid out.

Subsequently, in S21, the number of games X played in the slot machine 1 is counted. More specifically, a counter stored in the RAM 43 is read out to make “1” added thereto, and then stored into the RAM 43 again.

Next, the bonus game processing S18 executed in the slot machine 1 of the first embodiment will be described with reference to FIG. 16. FIG. 16 is a flowchart showing a bonus game processing program in the slot machine according to the first embodiment.

In the bonus game processing, firstly in S31, the main CPU 41 sets the number N of games in the bonus game. Here, the number of games in the bonus game is selected by lottery from 10 to 25, based on a sampled random number. The number N of games in the bonus game is stored in the RAM 43.

Then, in S32, a lottery processing for the bonus game is executed. More specifically, the main CPU 41 executes a random number generating program that is included in the lottery program stored in the RAM 43, to thereby select, among a predetermined number range (a range “0-185” for the reel 5L, a range “0-111” for the reel 5C, and a range “0-125” for the reel 5R), a random number corresponding to each of the three reels 5L, 5C, and 5R. Then, the main CPU 41 refers to the symbol lottery table D to F corresponding to the payout rate that is set based on the number of games played, and determines code numbers for the respective reels 5L, 5C, and 5R (see FIG. 2) based on three random numbers selected. Here, the symbol lottery table D corresponds to the payout rate 85% (FIG. 9), the symbol lottery table E corresponds to the payout rate 90% (FIG. 10), and the symbol lottery table F corresponds to the payout rate 95% (FIG. 11). The code numbers thus determined for the respective reels 5L, 5C, and 5R are stored into the RAM 43, and then the processing proceeds to S33. A method for determining code numbers for the respective reels 5L, 5C, and 5R based on three random numbers selected is exemplified by one using a table that presents in advance correspondences such as the code number 01 BLANK for a random number “0 to 20”, the code number 05 BLANK for a random number “20 to 40”. Alternatively, it may also be possible to detect a stopping position of the reel in the lottery and adopt a code number closest to the stopping position.

Subsequently, in S33, the main CPU 41 executes a reel rotation control processing. In the reel rotation control processing, the main CPU 41 starts rotation of all the reels 5L, 5C, and 5R, and then stops the rotation of the respective reels 5L, 5C, and 5R so that a combination of symbols determined in the bonus game lottery processing S32 is stopped on the payline L.

Then, in a payout adding processing S34, a credit value corresponding to a payout is added in accordance with the combination of symbols that has been stopped on the payline L in S33. The credit added in S34 will be paid out to the player later in the payout processing in S20.

Then, in S35, the main CPU 41 reads out the number N of games left in the bonus game, which is stored in the RAM 43. The main CPU 41 subtracts “1” from the number N, and then stores the number N thus subtracted into the RAM 43 again.

Then, in S36, the main CPU 41 determines whether the number N of the games in the bonus game reaches the number determined in S31 or not. More specifically, the main CPU 41 determines whether the number N of games stored in the RAM 43 becomes “0” or not. When the number N of games is not “0”, that is, when the number of bonus games played does not yet reach the number determined in S31 (S36: NO), the processing returns to S32 and the above-described processings are repeated. When the number N of games is “0”, that is, when the main CPU 41 determines that the number N reaches the number determined in S31 (S36: YES), the bonus game processing ends.

As thus far described above, in the slot machine 1 of the first embodiment, the payout rate is changed among 85%, 90%, and 95% based on the preset general payout rate and the number of games played (S14). In accordance with a symbol lottery table that corresponds to the payout rate thus changed, the game is controlled (S15 to S18). Accordingly, a wide range of payout rates can be set in the slot machine 1, without requiring the game shop side to perform a payout-rate changing operation. In addition, by changing the payout rate, customers in the game shop can be prevented from concentrating on a particular gaming machine. Besides, since waves occur in a game, a player is not bored even when he/she is playing the game for a long time.

Further, a gaming machine can be versatile, because the same gaming machine, which can set several levels of payout rates, can be applied to countries or regions in which different limitations are put on payout rates. That is, even when the setting table for 85% is used in a country that limits a payout rate to not lower than 90%, the numbers of games using the respective tables for 85%, 90%, and 95% are programmed at fixed values so that an average payout rate becomes not lower than 90%.

### Second Embodiment

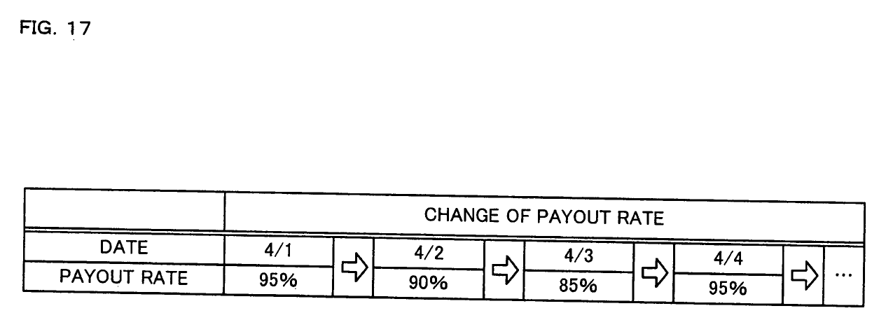

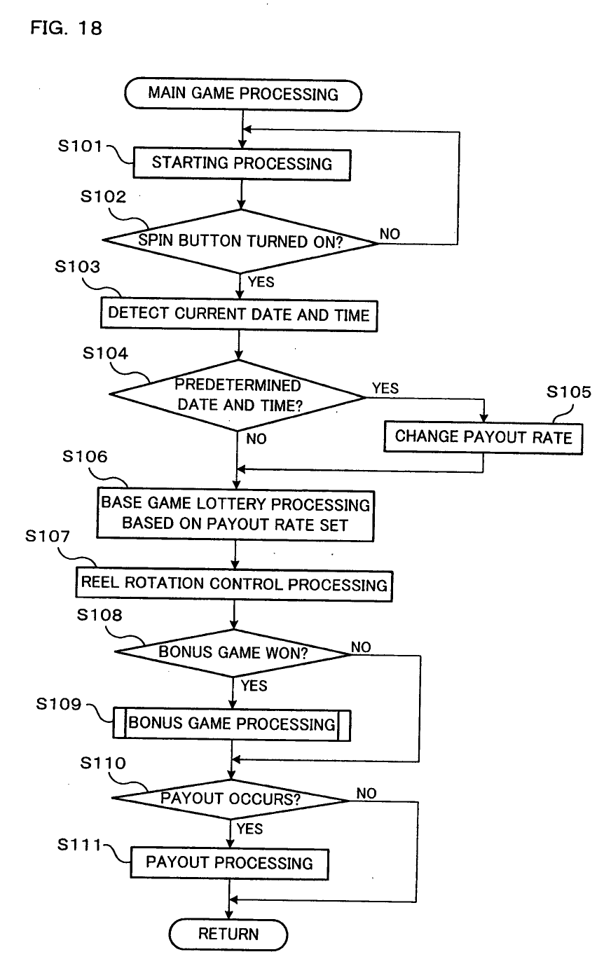

Next, a slot machine according to a second embodiment will be described with reference to FIGS. 17 and 18. In the following, the same reference numerals as put in FIGS. 1 to 16 showing the slot machine 1 of the first embodiment denote members identical or equivalent to those of the slot machine 1 of the first embodiment.

A schematic structure of a slot machine of the second embodiment is substantially the same as that of the slot machine 1 of the first embodiment. Also, various control processings are substantially the same as those in the slot machine 1 of the first embodiment.

However, the slot machine of the second embodiment changes a payout rate based on a current time and date, while the slot machine 1 of the first embodiment changes a payout rate based on the preset general payout rate and the number of games played. In this respect, the slot machine of the second embodiment differs from the slot machine 1 of the first embodiment.

In the following, a payout rate set in the slot machine of the second embodiment will be described with reference to FIG. 17. In the slot machine of the second embodiment, a payout rate is sequentially changed among 85%, 90%, and 95%, in accordance with elapse of time.

For example, on April 1, a payout rate is set at 95% and in this condition games are played. Then, at 0 o'clock on April 2, the payout rate is changed from 95% to 90%, and in this condition games are played. Then, at 0 o'clock on April 3, the payout rate is changed from 90% to 85%, and in this condition games are played. Then, at 0 o'clock on April 4, the payout rate is returned to 95% again. Thus, the above-described cycle is repeated every 24 hours.

Next, with reference to FIG. 18, a detailed description will be given to a sub processing in a main game processing that is executed in the slot machine of the second embodiment. FIG. 18 is a flowchart showing a main game processing program in the slot machine of the second embodiment. Here, a program shown by the flowchart in FIG. 18 is stored in the memory card 53, expanded in the RAM 43 of the slot machine, and executed by the main CPU 41.

As shown in FIG. 18, the main CPU 41 firstly executes a predetermined initial setting. Then, the main CPU 41 executes a starting processing for setting a coin insertion, a bet value betted on the payline L, and the like (S101). In this starting processing, a player performs a betting operation by inserting a coin or using the 1-BET button 16 or the MAX-BET button 17.

Then, in S102, the main CPU 41 determines whether the SPIN button 13 is inputted or not. Here, whether the SPIN button 13 is inputted or not is determined based on whether an input signal is received from the SPIN switch 13S or not.

When the SPIN button 13 is not inputted (S102: NO), the processing returns to the starting processing S101 again. At this time, operations such as changing a bet value can be made. When the SPIN button 13 is inputted (S102: YES), the main CPU 41 subtracts from the current credit value a bet value that has been set on the payline L based on operation of the 1-BET button 16 or the MAX-BET button 17. Then, the main CPU 41 stores the bet value into the RAM 43 as bet data.

Subsequently, in S103, the main CPU 41 detects a current time and date based on information given from the timer 29. In S104, the main CPU 41 determines whether or not the current time and date is a predetermined time and date at which a payout rate should be changed. The predetermined time and date has been preset in the slot machine. When it is determined that the current time and date is the time and date at which a payout rate should be changed (S104: YES), the set payout rate is changed (S105). When it is determined that the current time and date is not the time and date at which a payout rate should be changed (S104: NO), the processing proceeds to S106.

The slot machine of the second embodiment sequentially changes a payout rate at a predetermined timing in accordance with a current time and date, as shown in FIG. 17.

For example, when it is determined that 0 o'clock on April 2 has come, the payout rate is changed from 95% to 90%. When it is determined that 0 o'clock on April 3 has come, the payout rate is changed from 90% to 85%.

Subsequently, in S106, the main CPU 41 executes a base game lottery processing using the reels 5L, 5C, and 5R. More specifically, the main CPU 41 refers to the symbol lottery table A to C corresponding to the payout rate that is set based on a current time and date, and determines code numbers for the respective reels 5L, 5C, and 5R (see FIG. 2) based on three random numbers selected. Here, the symbol lottery table A corresponds to the payout rate 85% (FIG. 6), the symbol lottery table B corresponds to the payout rate 90% (FIG. 7), and the symbol lottery table C corresponds to the payout rate 95% (FIG. 8). The code numbers thus determined for the respective reels 5L, 5C, and 5R are stored into the RAM 43, and then the processing proceeds to S107.

In S106, moreover, a lottery is held for whether or not to proceed to a bonus game, too. By executing the random number generating program that is included in the lottery program stored in the RAM 43, the main CPU 41 selects a random number from the random number range “0-99” and determines, using the bonus game proceeding lottery table (FIG. 13), whether or not to proceed to a bonus game after the base game is finished.

Subsequently, in S107, the main CPU 41 executes a reel rotation control processing. In the reel rotation control processing, the main CPU 41 starts rotation of all the reels 5L, 5C, and 5R, and then stops the rotation of the respective reels 5L, 5C, and 5R so that a combination of symbols determined in the base game lottery processing S106 is stopped on the payline L. The reel rotation control processing is executed by the main CPU 41 and the sub CPU 61.

Subsequent processings S108 to S111 are the same as processings S17 to S20 in the main game processing executed in the slot machine 1 of the first embodiment (FIG. 15), and therefore descriptions thereof are omitted here.

As thus far described above, in the slot machine of the second embodiment, the payout rate is changed among 85%, 90%, and 95% based on the current time and date (S105). In accordance with a symbol lottery table that corresponds to the payout rate thus changed, the game is controlled (S106 to S109). Accordingly, a wide range of payout rates can be set in the slot machine, without requiring the game shop side to perform a payout-rate changing operation. In addition, by changing the payout rate, customers in the game shop can be prevented from concentrating on a particular gaming machine. Besides, since waves occur in a game along with elapse of time, a player is not bored even when he/she is playing the game for a long time. Further, since a payout rate is changed on a predetermined date or at a predetermined time, the payout rate can surely be changed in accordance with elapse of time.

Moreover, a manager of a casino or a hall can easily see a current situation. Therefore, it is possible to set a lottery table for a day on which a particular event is held.

### Third Embodiment

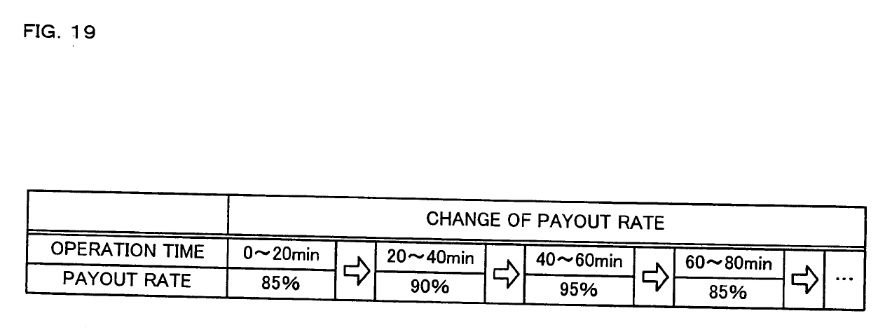

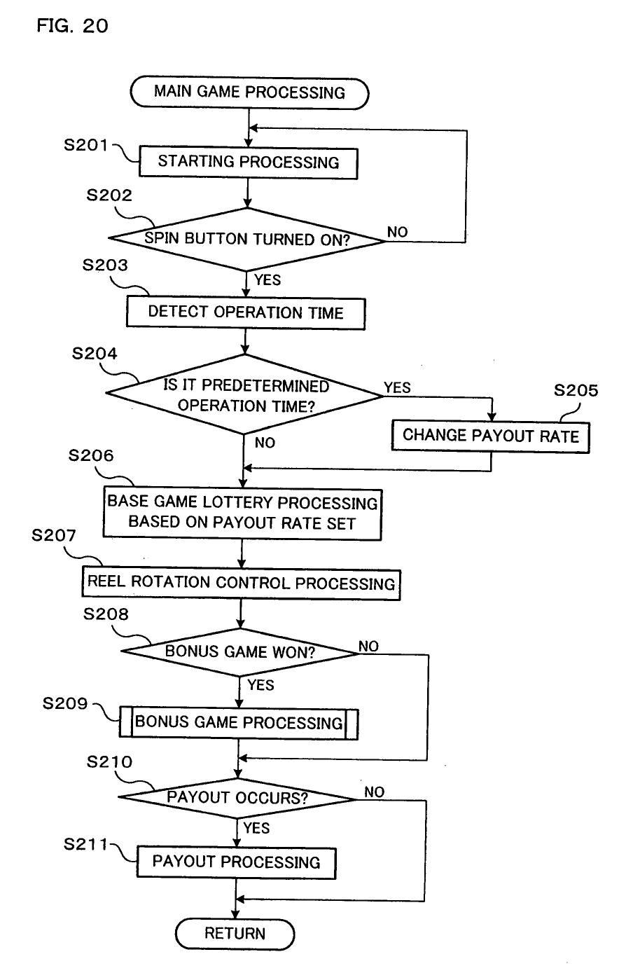

Next, a slot machine according to a third embodiment will be described with reference to FIGS. 19 and 20. In the following, the same reference numerals as put in FIGS. 1 to 16 showing the slot machine 1 of the first embodiment denote members identical or equivalent to those of the slot machine 1 of the first embodiment.

A schematic structure of a slot machine of the third embodiment is substantially the same as that of the slot machine 1 of the first embodiment. Also, various control processings are substantially the same as those in the slot machine 1 of the first embodiment.

However, the slot machine of the third embodiment changes a payout rate based on operation time, while the slot machine 1 of the first embodiment changes a payout rate based on the preset general payout rate and the number of games played. In this respect, the slot machine of the third embodiment differs from the slot machine 1 of the first embodiment.

In the following, a payout rate set in the slot machine of the third embodiment will be described with reference to FIG. 19. In the slot machine of the third embodiment, a payout rate is sequentially changed among 85%, 90%, and 95%, in accordance with elapse of operation time.

For example, in a period from when operation starts to when 20 minutes operation time elapses, a payout rate is set at 85% and in this condition games are played. Then, in a period from when the 20 minutes operation time elapsed to when 40 minutes operation time elapses, the payout rate is set at 90% and in this condition games are played. Then, in a period from when the 40 minutes operation time elapsed to when 60 minutes operation time elapses, the payout rate is set at 95% and in this condition games are played. Then, when 60 minutes operation time elapses, the payout rate is returned to 85% again. Thus, the above-described cycle is repeated every 20 minutes operation time.

Next, with reference to FIG. 20, a detailed description will be given to a sub processing in a main game processing that is executed in the slot machine of the third embodiment. FIG. 20 is a flowchart showing a main game processing program in the slot machine of the third embodiment. Here, a program shown by the flowchart in FIG. 20 is stored in the memory card 53, expanded in the RAM 43 of the slot machine, and executed by the main CPU 41.

As shown in FIG. 20, the main CPU 41 firstly executes a predetermined initial setting. Then, the main CPU 41 executes a starting processing for setting a coin insertion, a bet value betted on the payline L, and the like (S201). In this starting processing, a player performs a betting operation by inserting a coin or using the 1-BET button 16 or the MAX-BET button 17.

Then, in S202, the main CPU 41 determines whether the SPIN button 13 is inputted or not. Here, whether the SPIN button 13 is inputted or not is determined based on whether an input signal is received from the SPIN switch 13S or not.

When the SPIN button 13 is not inputted (S202: NO), the processing returns to the starting processing S201 again. At this time, operations such as changing a bet value can be made. When the SPIN button 13 is inputted (S202: YES), the main CPU 41 subtracts from the current credit value a bet value that has been set on the payline L based on operation of the 1-BET button 16 or the MAX-BET button 17. Then, the main CPU 41 stores the bet value into the RAM 43 as bet data.

Subsequently, in S203, the main CPU 41 detects operation time of the slot machine, based on information given from the timer 29. In S204, the main CPU 41 determines whether or not the operation time thus detected is predetermined operation time at which a payout rate should be changed. The predetermined operation time has been preset in the slot machine. When it is determined that it is time to change a payout rate (S204: YES), the set payout rate is changed (S205). When it is determined that it is not time to change a payout rate (S204: NO), the processing proceeds to S206.

The slot machine of the third embodiment sequentially changes a payout rate at a predetermined timing in accordance with elapse of operation time of the slot machine up to now, as shown in FIG. 19.

For example, when it is determined that 20 minutes operation time has elapsed, the payout rate is changed from 85% to 90%. When it is determined that 40 minutes operation time has elapsed, the payout rate is changed from 90% to 95%.

Subsequently, in S206, the main CPU 41 executes a base game lottery processing using the reels 5L, 5C, and 5R. More specifically, the main CPU 41 refers to the symbol lottery table A to C corresponding to the payout rate that is set based on current operation time, and determines code numbers for the respective reels 5L, 5C, and 5R (see FIG. 2) based on three random numbers selected. Here, the symbol lottery table A corresponds to the payout rate 85% (FIG. 6), the symbol lottery table B corresponds to the payout rate 90% (FIG. 7), and the symbol lottery table C corresponds to the payout rate 95% (FIG. 8). The code numbers thus determined for the respective reels 5L, 5C, and 5R are stored into the RAM 43, and then the processing proceeds to S207.

In S206, moreover, a lottery is held for whether or not to proceed to a bonus game, too. By executing the random number generating program that is included in the lottery program stored in the RAM 43, the main CPU 41 selects a random number from the random number range “0-99” and determines, using the bonus game proceeding lottery table (FIG. 13), whether or not to proceed to a bonus game after the base game is finished.

Subsequently, in S207, the main CPU 41 executes a reel rotation control processing. In the reel rotation control processing, the main CPU 41 starts rotation of all the reels 5L, 5C, and 5R, and then stops the rotation of the respective reels 5L, 5C, and 5R so that a combination of symbols determined in the base game lottery processing S206 is stopped on the payline L. The reel rotation control processing is executed by the main CPU 41 and the sub CPU 61.

Subsequent processings S208 to S211 are the same as processings S17 to S20 in the main game processing executed in the slot machine 1 of the first embodiment (FIG. 15), and therefore descriptions thereof are omitted here.

As thus far described above, in the slot machine of the third embodiment, the payout rate is changed among 85%, 90%, and 95% based on the current operation time (S205). In accordance with a symbol lottery table that corresponds to the payout rate thus changed, the game is controlled (S206 to S209). Accordingly, a wide range of payout rates can be set in the slot machine, without requiring the game shop side to perform a payout-rate changing operation. In addition, by changing the payout rate, customers in the game shop can be prevented from concentrating on a particular gaming machine. Besides, since waves occur in a game along with elapse of operation time of the gaming machine, a player is not bored even when he/she is playing the game for a long time. Further, in a casino for example, average operation time for one player to operate a gaming machine is 20 minutes. Accordingly, changing a payout rate every 20 minutes means changing a payout rate basically once in a play by one player, which can attract the player.

Here, a means for detecting presence of a player using an optical sensor or the like, or alternatively a player identification means such as a member's card may be provided additionally, to thereby make it possible to detect whether a gaming machine is actually in operation or not. When it is detected that the gaming machine is in operation, a predetermined time is measured.

### Fourth Embodiment

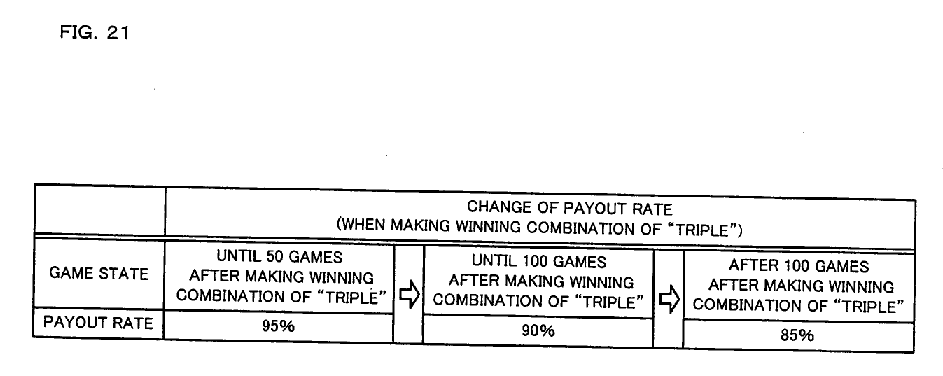

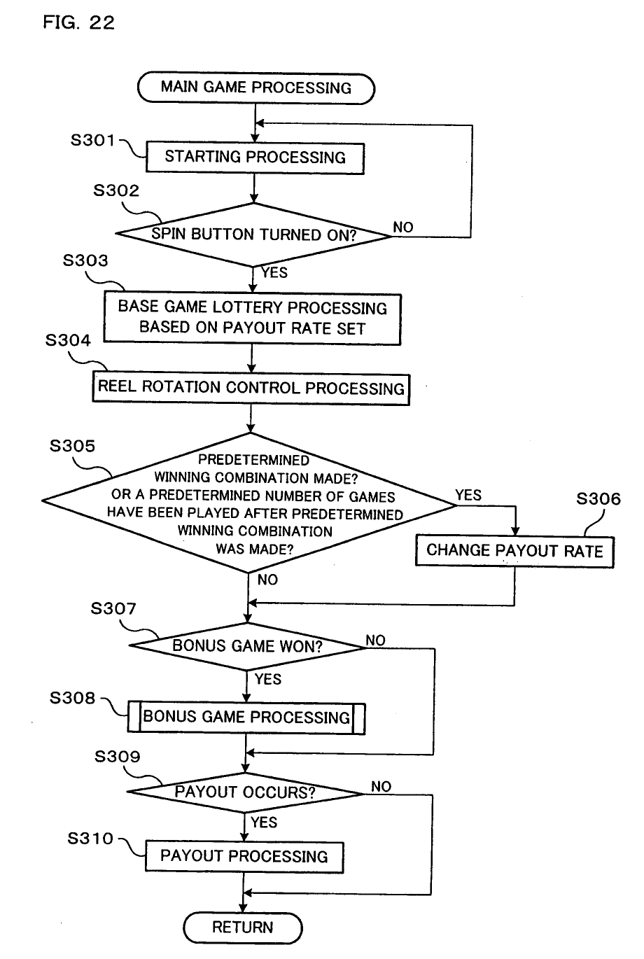

Next, a slot machine according to a fourth embodiment will be described with reference to FIGS. 21 and 22. In the following, the same reference numerals as put in FIGS. 1 to 16 showing the slot machine 1 of the first embodiment denote members identical or equivalent to those of the slot machine 1 of the first embodiment.

A schematic structure of a slot machine of the fourth embodiment is substantially the same as that of the slot machine 1 of the first embodiment. Also, various control processings are substantially the same as those in the slot machine 1 of the first embodiment.

However, the slot machine of the fourth embodiment changes a payout rate based on completion of a winning combination, while the slot machine 1 of the first embodiment changes a payout rate based on the preset general payout rate and the number of games played. In this respect, the slot machine of the fourth embodiment differs from the slot machine 1 of the first embodiment.

In the following, a payout rate set in the slot machine of the fourth embodiment will be described with reference to FIG. 21. In the slot machine of the fourth embodiment, a payout rate is sequentially changed among 85%, 90%, and 95%, in accordance with completion of a winning combination and subsequent progress of a game.

For example, in a period from when a winning combination of three “TRIPLE” symbols is made on the payline L to when 50 games have been played, a payout rate is set at 95% and in this condition games are played. Then, in a period from when the 50 games have been played to when 100 games have been played, the payout rate is set at 90% and in this condition games are played. Then, after the 100 games have been played, the payout rate is set at 85% and in this condition games are played.

Next, with reference to FIG. 22, a detailed description will be given to a sub processing in a main game processing that is executed in the slot machine of the fourth embodiment. FIG. 22 is a flowchart showing a main game processing program in the slot machine of the fourth embodiment. Here, a program shown by the flowchart in FIG. 22 is stored in the memory card 53, expanded in the RAM 43 of the slot machine, and executed by the main CPU 41.

As shown in FIG. 22, the main CPU 41 firstly executes a predetermined initial setting. Then, the main CPU 41 executes a starting processing for setting a coin insertion, a bet value betted on the payline L, and the like (S301). In this starting processing, a player performs a betting operation by inserting a coin or using the 1-BET button 16 or the MAX-BET button 17.

Then, in S302, the main CPU 41 determines whether the SPIN button 13 is inputted or not. Here, whether the SPIN button 13 is inputted or not is determined based on whether an input signal is received from the SPIN switch 13S or not.

When the SPIN button 13 is not inputted (S302: NO), the processing returns to the starting processing S301 again. At this time, operations such as changing a bet value can be made. When the SPIN button 13 is inputted (S302: YES), the main CPU 41 subtracts from the current credit value a bet value that has been set on the payline L based on operation of the 1-BET button 16 or the MAX-BET button 17. Then, the main CPU 41 stores the bet value into the RAM 43 as bet data.

Subsequently, in S303, the main CPU 41 executes a base game lottery processing using the reels 5L, 5C, and 5R. More specifically, the main CPU 41 refers to the symbol lottery table A to C corresponding to the payout rate that is set based on a current game state, and determines code numbers for the respective reels 5L, 5C, and 5R (see FIG. 2) based on three random numbers selected. Here, the symbol lottery table A corresponds to the payout rate 85% (FIG. 6), the symbol lottery table B corresponds to the payout rate 90% (FIG. 7), and the symbol lottery table C corresponds to the payout rate 95% (FIG. 8). The code numbers thus determined for the respective reels 5L, 5C, and 5R are stored into the RAM 43, and then the processing proceeds to S304.

In S303, moreover, a lottery is held for whether or not to proceed to a bonus game, too. By executing the random number generating program that is included in the lottery program stored in the RAM 43, the main CPU 41 selects a random number from the random number range “0-99” and determines, using the bonus game proceeding lottery table (FIG. 13), whether or not to proceed to a bonus game after the base game is finished.

Subsequently, in S304, the main CPU 41 executes a reel rotation control processing. In the reel rotation control processing, the main CPU 41 starts rotation of all the reels 5L, 5C, and 5R, and then stops the rotation of the respective reels 5L, 5C, and 5R so that a combination of symbols determined in the base game lottery processing S303 is stopped on the payline L. The reel rotation control processing is executed by the main CPU 41 and the sub CPU 61.

Then, in S305, the main CPU 41 determines whether a winning combination of “TRIPLE” (which means that three “TRIPLE” symbols are stopped on the payline) has been made in S303 or not, or whether a predetermined number of games have been played since the winning combination of “TRIPLE” was previously made. When it is determined that any one of the above-described conditions is satisfied (S305: YES), the set payout rate is changed (S306). When it is determined that neither of the above-described conditions is satisfied (S305: NO), the processing proceeds to S307.

The slot machine of the fourth embodiment sequentially changes a payout rate at a predetermined timing in accordance with completion of a winning combination and the number of games played after the completion, as shown in FIG. 21.

For example, when it is determined that the winning combination of “TRIPLE” has been made, a payout rate is changed to 95%. When it is determined that 50 games have been played since the winning combination of “TRIPLE” was made, the payout rate is changed from 95% to 90%. When it is determined that 100 games have been played since the winning combination of “TRIPLE” was made, the payout rate is changed from 90% to 85%.

Subsequent processings S307 to S310 are the same as processings S17 to S20 in the main game processing executed in the slot machine 1 of the first embodiment (FIG. 15), and therefore descriptions thereof are omitted here.

As thus far described above, in the slot machine of the fourth embodiment, the payout rate is changed among 85%, 90%, and 95% based on the fact that a particular winning combination has been made in a game (S306). In accordance with a symbol lottery table that corresponds to the payout rate thus changed, the game is controlled (S303 to S308). Accordingly, a wide range of payout rates can be set in the slot machine, without requiring the game shop side to perform a payout-rate changing operation. Besides, since waves occur in a game in accordance with a winning mode in the gaming machine, a player is not bored even when he/she is playing the game for a long time. The payout rate is changed upon making a win. Therefore, when a player wins, his/her expectation rises, which makes it likely that he/she will continue the game even after the win.

It may be possible to preset which lottery table will be changed for each winning combination. It may also be possible to change a lottery table simply when a predetermined winning combination is made.

### Fifth Embodiment

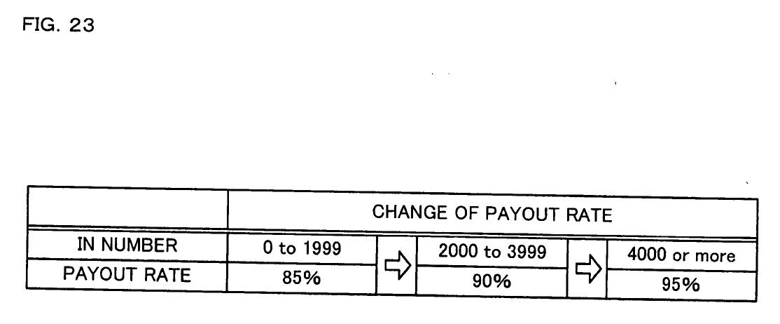

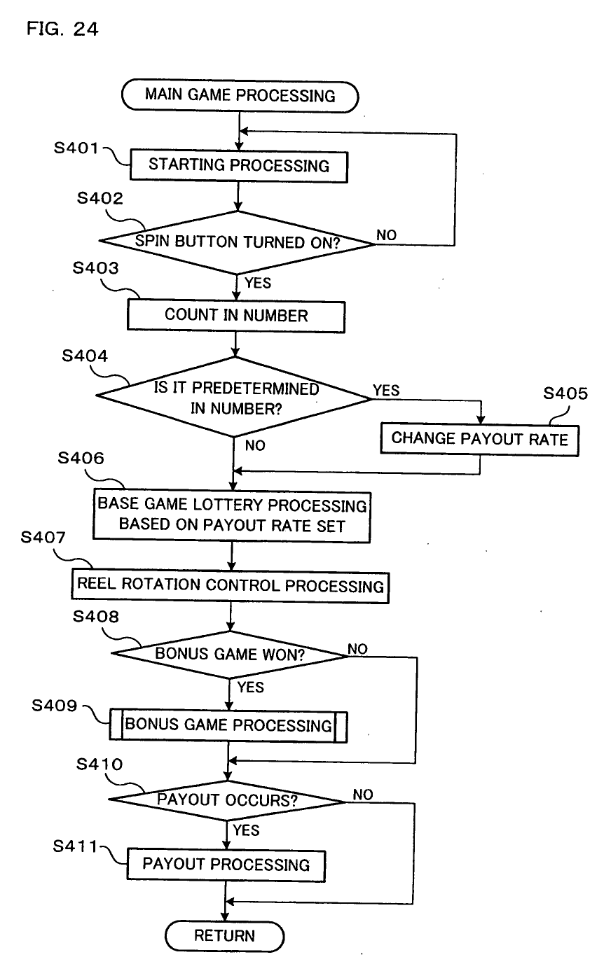

Next, a slot machine according to a fifth embodiment will be described with reference to FIGS. 23 and 24. In the following, the same reference numerals as put in FIGS. 1 to 16 showing the slot machine 1 of the first embodiment denote members identical or equivalent to those of the slot machine 1 of the first embodiment.

A schematic structure of a slot machine of the fifth embodiment is substantially the same as that of the slot machine 1 of the first embodiment. Also, various control processings are substantially the same as those in the slot machine 1 of the first embodiment.

However, the slot machine of the fifth embodiment changes a payout rate based on the number of in-coins that are inserted into the coin reception slot 21, while the slot machine 1 of the first embodiment changes a payout rate based on the preset general payout rate and the number of games played. In this respect, the slot machine of the fifth embodiment differs from the slot machine 1 of the first embodiment.

In the following, a payout rate set in the slot machine of the fifth embodiment will be described with reference to FIG. 23. In the slot machine of the fifth embodiment, a payout rate is sequentially changed among 85%, 90%, and 95%, in accordance with the number (a value) of coins inserted into the coin reception slot 21 by a player.

For example, when the number of coins inserted into the coin reception slot 21 by a player (which will hereinafter be referred to as an “IN number”) is 0 to 1999, a payout rate is set at 85% and in this condition games are played. When the IN number is 2000 to 3999, the payout rate is set at 90% and in this condition games are played. When the IN number is 4000 or more, the payout rate is set at 95% and in this condition games are played.

Next, with reference to FIG. 24, a detailed description will be given to a sub processing in a main game processing that is executed in the slot machine of the fifth embodiment. FIG. 24 is a flowchart showing a main game processing program in the slot machine of the fifth embodiment. Here, a program shown by the flowchart in FIG. 24 is stored in the memory card 53, expanded in the RAM 43 of the slot machine, and executed by the main CPU 41.

As shown in FIG. 24, the main CPU 41 firstly executes a predetermined initial setting. Then, the main CPU 41 executes a starting processing for setting a coin insertion, a bet value betted on the payline L, and the like (S401). In this starting processing, a player performs a betting operation by inserting a coin or using the 1-BET button 16 or the MAX-BET button 17.

Then, in S402, the main CPU 41 determines whether the SPIN button 13 is inputted or not. Here, whether the SPIN button 13 is inputted or not is determined based on whether an input signal is received from the SPIN switch 13S or not.

When the SPIN button 13 is not inputted (S402: NO), the processing returns to the starting processing S401 again. At this time, operations such as changing a bet value can be made. When the SPIN button 13 is inputted (S402: YES), the main CPU 41 subtracts from the current credit value a bet value that has been set on the payline L based on operation of the 1-BET button 16 or the MAX-BET button 17. Then, the main CPU 41 stores the bet value into the RAM 43 as bet data.

Then, in S403, the main CPU 41 counts the number (a value) of coins inserted into the coin reception slot 21. To be specific, the number of coins inserted in the starting processing S401 is detected by means of the coin counter 21C provided in the coin reception slot 21, and the number of coins thus detected is counted and stored into the RAM 43.

Then, determined in S404 is whether the IN number thus counted is a predetermined number at which a payout rate should be changed, or not. The predetermined number has been preset in the slot machine. When it is determined that the IN number reaches the number at which a payout rate should be changed (S404: YES), the set payout rate is changed (S405). When it is determined that the IN number does not reach the number at which a payout rate should be changed (S404: NO), the processing proceeds to S406.

The slot machine of the fifth embodiment sequentially changes a payout rate at a predetermined timing in accordance with the IN number of coins that have been inserted into the slot machine up to now, as shown in FIG. 23.

For example, when it is determined that the IN number reaches 2000, a payout rate is changed from 85% to 90%. When it is determined that the IN number reaches 4000, a payout rate is changed from 90% to 95%. That is, every time the number of inserted coins reaches 2000, a lottery table is changed. Here, the number of inserted coins at which a lottery table should be changed may be appropriately set, and also may be changed every time.

Subsequently, in S406, the main CPU 41 executes a base game lottery processing using the reels 5L, 5C, and 5R. More specifically, the main CPU 41 refers to the symbol lottery table A to C corresponding to the payout rate that is set based on the current IN number, and determines code numbers for the respective reels 5L, 5C, and 5R (see FIG. 2) based on three random numbers selected. Here, the symbol lottery table A corresponds to the payout rate 85% (FIG. 6), the symbol lottery table B corresponds to the payout rate 90% (FIG. 7), and the symbol lottery table C corresponds to the payout rate 95% (FIG. 8). The code numbers thus determined for the respective reels 5L, 5C, and 5R are stored into the RAM 43, and then the processing proceeds to S407.

In S406, moreover, a lottery is held for whether or not to proceed to a bonus game, too. By executing the random number generating program that is included in the lottery program stored in the RAM 43, the main CPU 41 selects a random number from the random number range “0-99” and determines, using the bonus game proceeding lottery table (FIG. 13), whether or not to proceed to a bonus game after the base game is finished.

Subsequently, in S407, the main CPU 41 executes a reel rotation control processing. In the reel rotation control processing, the main CPU 41 starts rotation of all the reels 5L, 5C, and 5R, and then stops the rotation of the respective reels 5L, 5C, and 5R so that a combination of symbols determined in the base game lottery processing S406 is stopped on the payline L. The reel rotation control processing is executed by the main CPU 41 and the sub CPU 61.

Subsequent processings S408 to S411 are the same as processings S17 to S20 in the main game processing executed in the slot machine 1 of the first embodiment (FIG. 15), and therefore descriptions thereof are omitted here.

As thus far described above, in the slot machine of the fifth embodiment, the payout rate is changed among 85%, 90%, and 95% based on the IN number which is equivalent to a value of the game media inserted (S405). In accordance with a symbol lottery table that corresponds to the payout rate thus changed, the game is controlled (S406 to S409). Accordingly, a wide range of payout rates can be set in the slot machine, without requiring the game shop side to perform a payout-rate changing operation. In addition, by changing the payout rate, customers in the game shop can be prevented from concentrating on a particular gaming machine. Besides, since waves occur in a game in accordance with progress of a game in the slot machine, a player is not bored even when he/she is playing the game for a long time. As the number of inserted coins increases, the payout rate gradually rises. This can raise player's expectation, and make a player use more coins.

### Sixth Embodiment

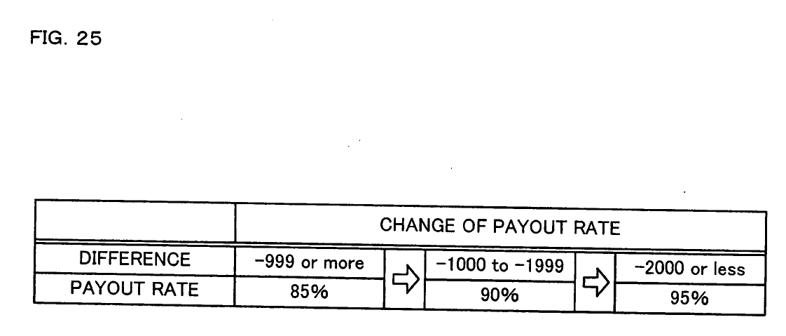

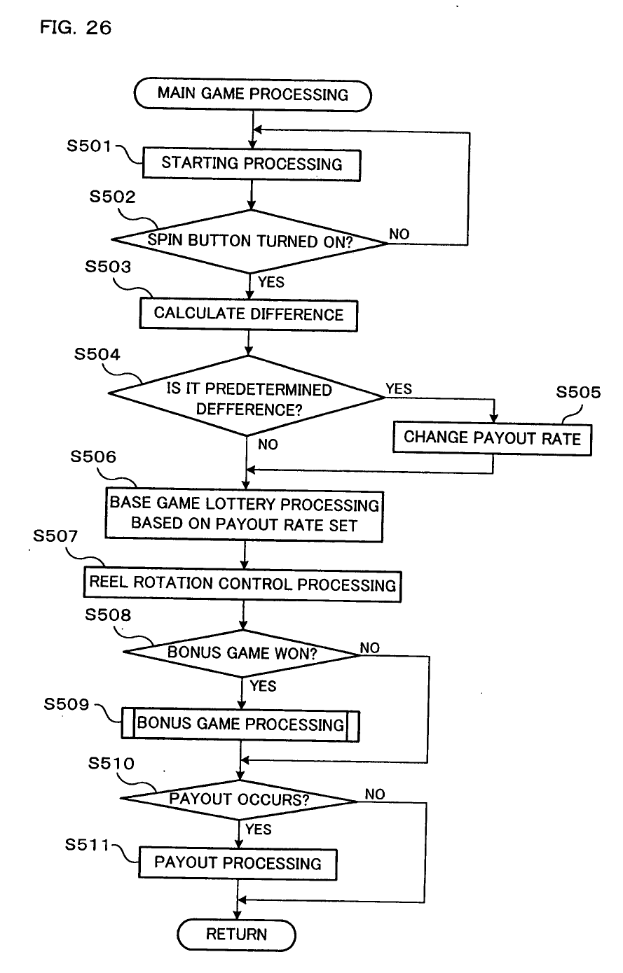

Next, a slot machine according to a sixth embodiment will be described with reference to FIGS. 25 and 26. In the following, the same reference numerals as put in FIGS. 1 to 16 showing the slot machine 1 of the first embodiment denote members identical or equivalent to those of the slot machine 1 of the first embodiment.

A schematic structure of a slot machine of the sixth embodiment is substantially the same as that of the slot machine 1 of the first embodiment. Also, various control processings are substantially the same as those in the slot machine 1 of the first embodiment.

However, the slot machine of the sixth embodiment changes a payout rate based on a difference between the IN number of coins inserted into the coin reception slot 21 and the number of coins paid out, while the slot machine 1 of the first embodiment changes a payout rate based on the preset general payout rate and the number of games played. In this respect, the slot machine of the sixth embodiment differs from the slot machine 1 of the first embodiment.

In the following, a payout rate set in the slot machine of the sixth embodiment will be described with reference to FIG. 25. In the slot machine of the sixth embodiment, a payout rate is sequentially changed among 85%, 90%, and 95%, in accordance with a difference between the number (a value) of coins inserted into the coin reception slot 21 by a player and the number (a value) of coins paid out to the player.

For example, a payout rate is set at 85% and in this condition games are played, when a difference between the number of coins inserted into the coin reception slot 21 by a player (which will hereinafter be referred to as an “IN number”) and the number of coins paid out (which will hereinafter be referred to as an “OUT number”) is equal to or larger than −999, which means any one of when the OUT number and the IN number are equal, when the OUT number is larger than the IN number, and when the IN number is larger than OUT number by less than 999. When the difference therebetween is −1000 to −1999, which means when the IN number is larger than the OUT number by 1000 to 1999, the payout rate is set at 90% and in this condition games are played. When the difference therebetween is equal to or smaller than −2000, which means when the IN number is larger than the OUT number by 2000 or more, the payout rate is set at 95% and in this condition games are played.

Next, with reference to FIG. 26, a detailed description will be given to a sub processing in a main game processing that is executed in the slot machine of the sixth embodiment. FIG. 26 is a flowchart showing a main game processing program in the slot machine of the sixth embodiment. Here, a program shown by the flowchart in FIG. 26 is stored in the memory card 53, expanded in the RAM 43 of the slot machine, and executed by the main CPU 41.

As shown in FIG. 26, the main CPU 41 firstly executes a predetermined initial setting. Then, the main CPU 41 executes a starting processing for setting a coin insertion, a bet value betted on the payline L, and the like (S501). In this starting processing, a player performs a betting operation by inserting a coin or using the 1-BET button 16 or the MAX-BET button 17.

Then, in S502, the main CPU 41 determines whether the SPIN button 13 is inputted or not. Here, whether the SPIN button 13 is inputted or not is determined based on whether an input signal is received from the SPIN switch 13S or not.

When the SPIN button 13 is not inputted (S502: NO), the processing returns to the starting processing S501 again. At this time, operations such as changing a bet value can be made. When the SPIN button 13 is inputted (S502: YES), the main CPU 41 subtracts from the current credit value a bet value that has been set on the payline L based on operation of the 1-BET button 16 or the MAX-BET button 17. Then, the main CPU 41 stores the bet value into the RAM 43 as bet data.

Then, in S503, the main CPU 41 calculates a difference between the number (a value) of coins inserted into the coin reception slot 21 and the number (a value) of coins paid out to the player. More specifically, the number of coins inserted in the starting processing S501 is detected by means of the coin counter 21C provided in the coin reception slot 21, and the number of coins thus detected is stored into the RAM 43. At the same time, the number of coins paid out in a payout processing S511 in each game is also stored into the RAM 43. By reading out the respective numbers of coins stored in the RAM 43, the main CPU 41 calculates out a difference.

Then, determined in S504 is whether the difference thus calculated reaches a predetermined value at which a payout rate should be changed, or not. The predetermined value has been preset in the slot machine. When it is determined that the difference reaches the value at which a payout rate should be changed (S504: YES), the set payout rate is changed (S505). When it is determined that the difference does not reach the value at which a payout rate should be changed (S504: NO), the processing proceeds to S506.

The slot machine of the sixth embodiment sequentially changes a payout rate at a predetermined timing in accordance with a difference between the OUT number and the IN number of coins inserted into the slot machine up to now, as shown in FIG. 25.

For example, when it is determined that a difference reaches −1000, which means when it is determined that the IN number is larger than the OUT number by 1000, a payout rate is changed from 85% to 90%. When it is determined that the difference reaches −2000, which means when it is determined that the IN number is larger than the OUT number by 2000, the payout rate is changed from 90% to 95%.

It may be possible to use the 95% table when the difference is a minus value while using the 85% table when the difference is a plus value. In addition, the number of difference may be appropriately set.

Subsequently, in S506, the main CPU 41 executes a base game lottery processing using the reels 5L, 5C, and 5R. More specifically, the main CPU 41 refers to the symbol lottery table A to C corresponding to the payout rate that is set based on the current difference between the IN number and the OUT number, and determines code numbers for the respective reels 5L, 5C, and 5R (see FIG. 2) based on three random numbers selected. Here, the symbol lottery table A corresponds to the payout rate 85% (FIG. 6), the symbol lottery table B corresponds to the payout rate 90% (FIG. 7), and the symbol lottery table C corresponds to the payout rate 95% (FIG. 8). The code numbers thus determined for the respective reels 5L, 5C, and 5R are stored into the RAM 43, and then the processing proceeds to S507.

In S506, moreover, a lottery is held for whether or not to proceed to a bonus game, too. By executing the random number generating program that is included in the lottery program stored in the RAM 43, the main CPU 41 selects a random number from the random number range “0-99” and determines, using the bonus game proceeding lottery table (FIG. 13), whether or not to proceed to a bonus game after the base game is finished.

Subsequently, in S507, the main CPU 41 executes a reel rotation control processing. In the reel rotation control processing, the main CPU 41 starts rotation of all the reels 5L, 5C, and 5R, and then stops the rotation of the respective reels 5L, 5C, and 5R so that a combination of symbols determined in the base game lottery processing S506 is stopped on the payline L. The reel rotation control processing is executed by the main CPU 41 and the sub CPU 61.

Subsequent processings S508 to S511 are the same as processings S17 to S20 in the main game processing executed in the slot machine 1 of the first embodiment (FIG. 15), and therefore descriptions thereof are omitted here.

As thus far described above, in the slot machine of the sixth embodiment, the payout rate is changed among 85%, 90%, and 95% based on the difference between a value of game media inserted and a value of game media paid out (S505). In accordance with a symbol lottery table that corresponds to the payout rate thus changed, the game is controlled (S506 to S509). Accordingly, a wide range of payout rates can be set in the slot machine, without requiring the game shop side to perform a payout-rate changing operation. In addition, since waves occur in a game in accordance with income and outgo of the game, a player is not bored even when he/she is playing the game for a long time. When an actual payout rate drops, a higher payout rate is set in the gaming machine. Therefore, balance of payment of the player can be maintained.

The present invention is not limited to the above-described examples. It is evident that various improvements and modification can be made without departing from the spirit and scope of the present invention.

For example, in the first to sixth embodiments, both the symbol lottery table (FIGS. 6 to 11) used in the base game and the symbol lottery table (FIGS. 6 to 11) used in the bonus game are changed in accordance with the set payout rate, to thereby adjust the payout rate. However, it may be possible to adjust the payout rate by changing only the symbol lottery table used in the base game while always fixing the symbol lottery table used in the bonus game. Alternatively, it may also be possible to adjust the payout rate by changing only the symbol lottery table used in the bonus game while always fixing the symbol lottery table used in the base game. Alternatively, it may also be possible to adjust the payout rate by changing the bonus game proceeding lottery table, which is used for determining by lottery whether or not to proceed to the bonus game, while always fixing the symbol lottery tables used in the base game and the bonus game.

In the first to sixth embodiments, a free game is given as the bonus game, and in the free game the reels 5L, 5C, and 5R are rotated at predetermined times without using a coin. However, the bonus game may be in any from. For example, a selective bonus game may be adopted in which a player selects one of options displayed on the lower image display panel 6 so that he/she obtains a payout associated with the option.

In the first to sixth embodiments, when a predetermined condition such as the number of games played, time, or the like is satisfied, the payout rate is changed among three payout rates of 85%, 90%, and 95%. However, several change patterns for changing the payout rates may be prepared in advance. In this case, the payout rate is changed in accordance with a change pattern selected from the several change patterns. Besides, the first to sixth embodiments may be in any combination. For example, it may be possible that a selected change pattern is changed to another change pattern when a predetermined condition such as the number of games played, time, or the like is satisfied.

In the first to sixth embodiments, a predetermined condition (for example, a condition that the number of games played reaches a predetermined value or that a current time is a predetermined time) is satisfied, the payout rate is change to another payout rate without fail. However, it may also be possible that, when a predetermined condition is satisfied, whether the payout rate is changed to another payout rate or not is selected at random and then change the payout rate based on a result of the selection.

In addition, the number of symbol lottery tables may be arbitrary, although in the above-described examples three kinds of symbol lottery tables 85%, 90%, and 95% are prepared. Besides, an additional lottery may be held for every game in order to determine whether or not to change the symbol lottery table. For example, when the symbol lottery table for the payout rate 95% is being used, a lottery is held in every game in order to determine whether or not to change the symbol lottery table to the symbol lottery table for the payout rate 90% or 85%. When the symbol lottery table for the payout rate 90% is being used, a lottery is held in every game in order to determine whether or not to change the symbol lottery table to the symbol lottery table for the payout rate 85% or 95%. Here, whether or not to change a table, and which table will be used may be determined not in every game but in every three games or every time period.

While this invention has been described in conjunction with the specific embodiments outlined above, it is evident that many alternatives, modifications and variations will be apparent to those skilled in the art. Accordingly, the preferred embodiments of the invention as sets forth above are intended to be illustrative, not limiting. Various changes may be made without departing from the spirit and scope of the invention as defined in the following claims.

What is claimed is:

1. A gaming machine comprising:
a game medium insertion unit into which a game medium is inserted;
a payout rate setting unit that sets a payout rate of the gaming machine at one of a plurality of levels of payout rates;
a game control unit that controls a game based on a payout rate set by the payout rate setting unit; and
a game medium payout unit that pays out a game medium to a player based on a game result and a game medium inserted into the game medium insertion unit,
wherein the gaming machine comprises a payout rate changing unit that changes a payout rate set by the payout rate setting unit to another payout rate at a predetermined timing.

2. The gaming machine according to claim 1, wherein:
the gaming machine comprises a time detection unit that detects a current date or a current time; and
when a predetermined date or time comes, the payout rate changing unit changes a payout rate to another payout rate.

3. The gaming machine according to claim 1, wherein:
the gaming machine comprises an operation time detection unit that detects operation time of the gaming machine; and
when operation time of the gaming machine reaches a predetermined time, the payout rate changing unit changes a payout rate to another payout rate.

4. The gaming machine according to claim 1, wherein:
the gaming machine comprises a win determination unit that determines, based on a result of game control made by the game control unit, whether a particular kind of win is made during a game or not; and
when the win determination unit determines that a particular kind of win is made, the payout rate changing unit changes a payout rate to another payout rate.

5. The gaming machine according to claim 1, wherein:
the gaming machine comprises a value counting unit that counts a value of a game medium inserted into the game medium insertion unit; and
when a game medium having a predetermined value is inserted into the game medium insertion unit, the payout rate changing unit changes a payout rate to another payout rate.

6. The gaming machine according to claim 1, wherein:
the gaming machine comprises a value calculation unit that calculates a difference between a value of a game medium inserted into the game medium insertion unit and a value of a game medium paid out by the game medium payout unit; and
when the value calculation unit calculates out a predetermined value difference, the payout rate changing unit changes a payout rate to another payout rate.

7. The gaming machine according to claim 1, wherein:
the gaming machine comprises a game counting unit that counts the number of games that have been played by the game control unit since the payout rate changing unit set or changed a payout rate; and
when the number of games counted by the game counting unit reaches a predetermined number, the payout rate changing unit changes a payout rate to another payout rate.

8. The gaming machine according to claim 1, wherein:
the gaming machine comprises a selection unit that selects at random whether or not to change a payout rate to another payout rate at the predetermined timing; and
when the selection unit selects to change the payout rate, the payout rate changing unit changes a payout rate to another payout rate.

9. The gaming machine according to claim 5, wherein:
the game medium is a predetermined coin;
the value counting unit counts the number of coins inserted into the game medium insertion unit; and
in accordance with the number of coins inserted, the payout rate changing unit changes a payout rate to another payout rate.

10. The gaming machine according to claim 6, wherein:
the game medium is a predetermined coin;
the value calculation unit calculates a difference between the number of coins inserted into the game medium insertion unit and the number of coins paid out by the game medium payout unit; and
in accordance with a difference between the numbers of coins thus calculated, the payout rate changing unit changes a payout rate to another payout rate.

11. A gaming machine comprising:
a display that displays a game; and
a game control unit that controls the display,
wherein the control unit:
executes the game based on a first payout rate;
stores a numerical value that is updated along with execution of the game; and
executes the game based on a second payout rate that is different from the first payout rate, in a case where the previously-stored numerical value becomes a certain value associated with the first payout rate beforehand.

12. The gaming machine according to claim 11, wherein, until the stored numerical value becomes a certain numerical value associated with the second payout rate beforehand, the control unit executes the game based on the second payout rate.

13. The gaming machine according to claim 12, wherein the numerical value associated with the first payout rate beforehand and the numerical value associated with the second payout rate beforehand are set based on a predetermined payout rate, the first payout rate, and the second payout rate.
